(19) United States
(12) Patent Application Publication
(10) Pub. No.: US 2026/0040251 A1
(43) Pub. Date: Feb. 5, 2026

(54) LOCATION INFORMATION FOR MOBILITY IN NTN

(71) Applicant: Telefonaktiebolaget LM Ericsson (PUBL), Stockholm (SE)

(72) Inventors: Johan RUNE, LIDINGÖ (SE); Robert KARLSSON, Sundbyberg (SE); Jonas SEDIN, BRENTFORD Greater London (GB); Gabriel LORENTZSON, UPPSALA (SE)

(21) Appl. No.: 18/996,233

(22) PCT Filed: Aug. 4, 2023
(86) PCT No.: PCT/SE2023/050779

§ 371 Date: Jan. 17, 2025

Related U.S. Application Data
(60) Provisional application No. 63/370,848, filed on Aug. 9, 2022.

(51) Int. Cl. H04W 56/00; G01S 19/03; H04W 64/00

(52) U.S. Cl. CPC H04W 56/0045; G01S 19/03; H04W 64/00

(57) ABSTRACT

According to some embodiments, a method is performed by a wireless device. The method comprises obtaining global navigation satellite system (GNSS) location information associated with the wireless device and transmitting a status of the GNSS location information to a network node. The status may comprise a remaining amount of time that the GNSS location information is valid.

### TECHNICAL FIELD

Embodiments of the present disclosure are directed to wireless communications and, more particularly, to location information for mobility in a non-terrestrial network (NTN).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Third Generation Partnership Project (3GPP) Background

3GPP Release 8 specifies the Evolved Packet System (EPS). EPS is based on the Long-Term Evolution (LTE) radio network and the Evolved Packet Core (EPC). It was originally intended to provide voice and mobile broadband (MBB) services but has continuously evolved to broaden its functionality. Since Release 13, narrowband Internet of things (NB-IoT) and LTE for machines (LTE-M) are part of the LTE specifications and provide connectivity to massive machine type communications (mMTC) services.

3GPP Release 15 specifies the fifth generation (5G) system (5GS). 5GS is a new generation radio access technology intended to serve use cases such as enhanced mobile broadband (eMBB), ultra-reliable and low latency communication (URLLC) and mMTC services. 5G includes the New Radio (NR) access stratum interface and the 5G core network (5GC). The NR physical and higher layers reuse parts of the LTE specification, and additional components are introduced when motivated by the new use cases. One such component is the introduction of a sophisticated framework for beam forming and beam management to extend the support of the 3GPP technologies to a frequency range going beyond 6 GHz

In Release 15, 3GPP started the work to prepare NR for operation in a non-terrestrial network (NTN). The work was performed within the Study Item “NR to support Non-Terrestrial Networks” and resulted in 3GPP TR 38.811. In Release 16, the work to prepare NR for operation in a NTN continued with the Study Item “Solutions for NR to support Non-Terrestrial Network,” which resulted in 3GPP TR 38.821.

The Release 16 study item resulted in a Work Item being agreed for NR in Release 17, “Solutions for NR to support non-terrestrial networks (NTN)”, which is described in the Work Item Description RP-193234.

3GPP Release 13 includes a work item for Narrowband IoT (NB-IoT). The objective of the IoT work item was to specify a radio access for cellular internet of things (IoT) that addresses improved indoor coverage, support for massive number of low throughput devices, not sensitive to delay, ultra-low device cost, low device power consumption and (optimized) network architecture.

NB-IoT may be described as a narrowband version of LTE. Similar to eMTC, NB-IoT uses increased acquisition times and time repetitions to extend the system coverage. The repetitions may be seen as a third level of retransmissions added at the physical layer as a complement to those at medium access control (MAC) hybrid automatic repeat request (HARQ) and radio link control (RLC) automatic repeat request (ARQ). A NB-IoT downlink carrier is defined by 12 orthogonal frequency division multiplexing (OFDM) sub-carriers, each of 15 kHz, giving a total baseband bandwidth of 180 kHz. When multiple carriers are configured, several 180 kHz carriers may be used, e.g., for increasing the system capacity, inter-cell interference coordination, load balancing, etc. This design gives NB-IoT a high deployment flexibility.

NB-IoT supports three different deployment scenarios or modes of operation. Stand-alone operation, guard-band operation, and in-band operation.

Stand-alone operation uses, for example, the spectrum currently being used by global system for mobile communication (GSM) enhanced data rate for GSM evolution (EDGE) radio access network (GERAN) systems as a replacement of one or more GSM carriers. In principle. it operates on any carrier frequency that is neither within the carrier of another system nor within the guard band of another system's operating carrier. The other system may be another NB-IoT operation or any other radio access technology (RAT) e.g., LTE.

Guard band operation uses the unused resource blocks within an LTE carrier's guard band. The term guard band may also interchangeably be referred to as guard bandwidth. As an example, for LTE bandwidth of 20 MHz (i.e., Bw1=20 MHz or 100 RBs), the guard band operation of NB-IoT may place anywhere outside the central 18 MHz but within 20 MHz LTE bandwidth.

In-band operation uses resource blocks within a normal LTE carrier. The in-band operation may also interchangeably be referred to as in-bandwidth operation. More generally, the operation of one RAT within the bandwidth of another RAT is also referred to as in-band operation. As an example, in a LTE bandwidth of 50 RBs (i.e., Bw1=10 MHz or 50 RBs), NB-IoT operation over one resource block (RB) within the 50 RBs is referred to as in-band operation.

NB-IoT defines anchor and non-anchor carriers. On an anchor carrier, a user equipment (UE) assumes that anchor specific signals including narrowband primary synchronization signal (NPSS)/narrowband secondary synchronization signal (NSSS)/narrowband physical broadcast channel (NPBCH)/narrowband system information base (SIB-NB) are transmitted in the downlink. On anon-anchor carrier, the UE does not assume that NPSS/NSSS/NPBCH/SIB-NB are transmitted in downlink. The anchor carrier is transmitted on at least subframes #0, #4, #5 in every frame and subframe #9 in every other frame. Additional downlink subframes in a frame may also be configured on the anchor carrier by means of a downlink bit map. The anchor carriers transmitting NPBCH/SIB-NB also contains narrowband reference signal (NRS).

The non-anchor carrier contains NRS during certain occasions and UE specific signals such as narrowband physical downlink control channel (NPDCCH) and narrowband physical downlink shared channel (NPDSCH). NRS, NPDCCH and NPDSCH are also transmitted on the anchor carrier. The resources for a non-anchor carrier are configured by the network, i.e., the eNB. The non-anchor carrier may be transmitted in any subframe as indicated by a downlink bit map. For example, the eNB signals a downlink bit map of downlink subframes using a Radio Resource Control (RRC) message (DL-Bitmap-NB) indicating which are configured as a non-anchor carrier. The anchor carrier and/or non-anchor carrier may typically be operated by the same network node (eNB) e.g., by the serving cell. But the anchor carrier and/or non-anchor carrier may also be operated by different network nodes (i.e., different eNBs).

In connected state, in the 3GPP specifications referred to as the RRC_CONNECTED state, the UE has an active connection to the network for sending and receiving data and signaling. In connected state, mobility is controlled by the network to ensure connectivity is maintained to the UE without interruption or noticeable degradation of the provided service as the UE moves between the cells within the network.

Connected state mobility is also known as handover. During handover, the UE is moved from a source node using a source cell connection, to a target node using a target cell connection where the target cell connection is associated with a target cell controlled by the target node. In other words, during a handover, the UE moves from the source cell to a target cell. The source node and the target node may also be referred to as the source access node and the target access node or the source radio network node and the target radio network node. In the 5G system the source node and the target node are referred to as the source gNB and the target gNB.

As requested by the network, a UE in RRC_CONNECTED state is required to search and perform measurements on neighbor cells both on the current carrier frequency (intra-frequency) as well as on other carrier frequencies (inter-frequency). The UE does not make autonomous decisions when to trigger a handover to a neighbor cell (except to some extent when the UE is configured for conditional handover). Instead, the UE sends the measurement results from the performed measurements on serving and neighboring cells to the network, where a decision is made whether to perform a handover to one of the neighbor cells.

Thus, upon receiving a measurement report from the UE indicating that it may be preferable to move the UE's RRC connection to a neighbor cell (e.g., because the measurement report indicates that the radio link in the service cell is deteriorating and/or that the radio channel quality in the neighbor cell has become (significantly) better than the radio channel quality in the serving cell), the network may send a message to the UE to instruct the UE to execute a handover. The message is an RRCReconfiguration message with a reconfigurationWithSync information element (IE). The message is often informally referred to as a “handover command” (although a HandoverCommand is really an inter-gNB RRC message that is transferred in the “Target NG-RAN node To Source NG-RAN node Transparent Container” IE in the Handover Request Acknowledge XnAP message during preparation of an Xn handover and in the “Target to Source Transparent Container” IE in the Handover Request Acknowledge NG Application Protocol (NGAP) message and the Handover Command NGAP message during preparation of an NG handover).

In some cases, the source node and the target node are different nodes, such as different gNBs. Such a case is referred to as an inter-node or inter-gNB handover. In other cases, the source node and the target node are one and the same node, such as the same gNB. Such a case is referred to as an intra-node or intra-gNB handover and covers the case when the source and target cells are controlled by the same node. In yet another case, handover is performed within the same cell and thus also within the same node controlling that cell. These cases are referred to as intra-cell handover and may be performed to refresh security parameters.

It should also be understood that the source node (or source access node) and the target node (target access node) refer to a role served by a given access node during a handover of a specific UE. For example, a given gNB may serve as source gNB during handover of one UE, while it also serves as the target gNB during handover of a different UE. For an intra-node or intra-cell handover of a given UE, the same gNB serves both as the source gNB and target gNB for that UE.

An inter-node handover in NR may further be classified as an Xn-based or NG-based handover depending on whether the source and target node communicate directly using the Xn interface or indirectly via the core network (through one or two access and mobility management function(s) (AMF(s))) using NG interfaces.

During an inter-node handover, after the handover decision has been made in the source gNB, the handover execution is preceded by a handover preparation phase consisting of communication between the source gNB and the target gNB. During the preparation phase, the source gNB provides the target gNB with state information related to the UE (referred to as the UE context), e.g. information about the UE's protocol data unit (PDU) session resources (e.g. quality of service (QoS) flow(s)) and various other configuration information, and the target gNB performs admission control (and assumedly accepts the handover) and returns indications of the admitted PDU session resources (e.g. QoS flow(s)) and the configuration that the UE should apply when accessing the target cell. The UE configuration the target gNB provides is included in an inter-gNB RRC message referred to as “HandoverCommand” and is formatted as an RRCReconfiguration message (including a reconfigurationWithSync IE). The source gNB then forwards the RRCReconfiguration message (i.e., the handover command) to the UE, which triggers the UE to execute the handover (by releasing its connection in the source cell, synchronizing with the target cell, and initiating a random access procedure in the target cell to establish a connection). In the third message of the random access procedure in the target cell the UE sends an RRCReconfigurationComplete message (often referred to as a Handover Complete message) to acknowledge the RRCReconfiguration message that triggered the handover execution and to confirm the successful execution of the handover.

FIG. 1 is an example signaling flow between the UE, the source gNB and the target gNB during an Xn-based inter-gNB handover in NR. A slightly more detailed signaling flow for the same Xn-based inter-gNB handover is illustrated in FIG. 2.

Note that control plane data (i.e., RRC messages such as the measurement report, handover command and handover complete messages) are transmitted on signaling radio bearers (SRBs), while the user plane data is transmitted on data radio bearers (DRBs).

As illustrated in FIG. 1, at steps 301-302 the UE has an active connection to the source gNB where user data is sent and received to/from the network. Due to a trigger in the source gNB, e.g., a measurement report received from the UE, the source gNB decides to handover the UE to a target (neighbor) cell controlled by the target gNB.

At step 303, the source gNB sends the XnAP HANDOVER REQUEST message to the target gNB passing a transparent RRC container with information to prepare the handover at the target side. The information includes, for example, the target cell identifier, the target security key, the current source configuration and UE capabilities.

At step 304, the target gNB prepares the handover and responds with the XnAP HANDOVER REQUEST ACKNOWLEDGE message to the source gNB, which includes the handover command (an RRCReconfiguration message containing the reconfigurationWithSync field) to be sent to the UE. The handover command includes configuration information that the UE should apply once it connects to the target cell, e.g., random access configuration, a new cell radio network temporary identifier (C-RNTI) assigned by the target node, security parameters, etc.

At step 305, the source gNB triggers the handover by sending the handover command (received from the target gNB in the previous step) to the UE. Upon reception of the handover command, at step 306, the UE releases the connection to the old (source) cell, starts the handover supervision timer T304, and starts to synchronize to the new (target) cell.

At steps 307-309, the source gNB stops scheduling any further downlink user data to the UE and sends the XnAP SN STATUS TRANSFER message to the target gNB indicating the latest Packet Data Convergence Protocol (PDCP) sequence number (SN) transmitter and receiver status. The source gNB now also starts to forward downlink user data received from the core network to the target gNB, which buffers the data for now.

At step 310, once the UE completes the random access procedure in the target cell, the UE stops the T304 timer and sends the handover complete message to the target gNB.

Upon receiving the handover complete message, at step 311, the target gNB starts sending (and receiving) user data to/from the UE. The target gNB requests the core network (CN) to switch the downlink user data path between the user plane function (UPF) and the source node to the target node (communication to the CN is not shown in FIG. 1). Once the path switch is completed, the target gNB sends the XnAP UE CONTEXT RELEASE message to the source gNB to release all resources associated to the UE.

FIG. 2 is another example signaling flow for Xn-based inter-gNB handover in NR. In NR, the following principles are used for handovers (or in more general terms, mobility in RRC_CONNECTED state). Mobility in RRC_CONNECTED state is network-controlled because the network has the best information regarding the current overall situation, such as load conditions, resources in different nodes, available frequencies, etc. The network may also consider the situation of many UEs in the network, for example, from a resource allocation perspective.

The network prepares a target cell before the UE accesses that cell. The source gNB provides the UE with the RRC configuration to be used in the target cell, including SRB1 configuration to send handover complete. The source gNB in turn receives the RRC configuration from the target gNB in the form of a HandoverCommand inter-node RRC message included in the HANDOVER REQUEST ACKNOWLEDGE XnAP message (where the HandoverCommand is included in the “Target NG-RAN node To Source NG-RAN node Transparent Container” IE).

In the RRC configuration that the target gNB provides to the UE via the source gNB, the target gNB configures the UE with a C-RNTI to be used in the target cell. The target gNB leverages the C-RNTI to identify the UE from Msg3 on MAC level for the handover complete message (which is an RRCReconfigurationComplete message transmitted by the UE in the target cell to indicate the successful completion of the handover). Thus, there is no context fetching, unless a failure occurs, because the UE context was already transferred to the target gNB during the handover preparation (in the HANDOVER REQUEST XnAP message in the case of Xn handover).

To speed up the handover, the network provides needed information on how to access the target cell, e.g., random access channel (RACH) configuration, so the UE does not have to acquire system information (SI) (other than the master information base (MIB)) prior to the handover. The information is included in the HandoverCommand and thus in the target cell RRC configuration sent to the UE.

The UE may be provided with contention free random access (CFRA) resources (in the above mentioned RRC configuration forwarded to the UE by the source gNB). The CFRA resources consist of one or more CFRA preamble(s) and may also contain CFRA occasions (i.e., physical random access channel (PRACH) transmission resources that are not included in the common PRACH configuration). For CFRA, the target gNB identifies the UE from the random access preamble (Msg1). The principle is that the procedure may be optimized with dedicated resources.

Security is prepared before the UE accesses the target cell, i.e., security keys must be refreshed before sending the handover complete message (i.e., the RRCReconfigurationComplete message), so that new keys are used to encrypt and integrity protect the handover complete message, enabling verification in the target cell.

The target cell RRC configuration may be provided to the UE in two different forms: full configuration or delta configuration. In the former case, the provided RRC configuration is complete and self-contained, but a delta configuration only contains the configuration parts that are different in the target cell than in the source cell. The advantage of delta configuration is that the size of the HandoverCommand may be minimized.

As previously described, handover typically occurs when the channel quality of the serving cell is degrading. The network is in control and bases the handover decision on measurement reports from the UE. In a typical case, the UE is configured to send a measurement report when an A3 event (neighbor cell quality becomes offset better than serving cell quality) is fulfilled. This will then trigger the gNB to decide to pursue a handover for the UE with the target cell being selected based on the reported neighbor cell measurements. If this is an inter-gNB neighbor cell, the serving gNB initiates the handover preparation by sending a Handover Request XnAP message to the neighbor gNB and the neighbor gNB responds with a Handover Request Acknowledge XnAP message containing, in the form of a HandoverCommand, the RRC configuration the UE should apply when connecting to the target cell. The serving (source) gNB then forwards the HandoverCommand to the UE as an RRCReconfiguration message. When the UE receives this message, it releases the source cell and starts the procedure of connecting to the target cell (i.e., synchronizing with the target cell and performing random access).

However, given the typical circumstances for handover, i.e., that the channel quality in the serving (source) cell is deteriorating, the handover operation is quite susceptible to errors. One solution is conditional handover (CHO)

FIG. 3 includes two flow diagrams illustrating two error cases addressed by CHO. As illustrated in the flow diagram on the left, one potential error associated with handover is that the measurement report from the UE, which would trigger the gNB to initiate the handover, never reaches the gNB because of too many transmission/reception errors. Another potential error is illustrated in the flow diagram on the right, where all handover preparations are successful, but the gNB fails to reach the UE with the RRCReconfiguration message constituting the Handover Command. Both errors are typically caused by a serving cell channel quality degrading faster than expected.

To combat such errors, the special variant of handover referred to as conditional handover was introduced in 3GPP Release 16. The CHO feature facilitates the serving gNB to configure a UE to autonomously trigger handover execution when a handover execution condition (or trigger condition) configured by the serving gNB is fulfilled. To realize this feature, the serving gNB includes a handover execution condition—often referred to as a CHO execution condition—together with the Handover Command forwarded from the candidate target gNB. This is configured in the condExecutionCond-r16 IE in the ASN.1 code in the RRC specification 3GPP TS 38.331 version 17.0.0.

Release 16 of the 3GPP standards supports configuration of three triggering events, which in the context of CHO are referred to as conditional events (CondEvents). The supported CondEvents are CondEvent A3, CondEvent A4 and CondEvent A5, which are reused from the A3, A4 and A5 events of the radio resource management (RRM) framework. When used as CondEvents, A3 is defined as “Conditional reconfiguration candidate becomes amount of offset better than PCell/PSCell”, A4 is defined as “Conditional reconfiguration candidate becomes better than absolute threshold”, and A5 is defined as “PCell/PSCell becomes worse than absolute threshold1 and Conditional reconfiguration candidate becomes better than another absolute threshold2”. Furthermore, the specification also allows the combination of two events, whose conditions both have to be fulfilled for the duration of the configured time-to-trigger period, to trigger the CHO execution.

CHO is applicable for both intra-gNB handover and inter-gNB handover. The remainder of this CHO background description looks at the feature in the inter-gNB CHO case, because this is the most comprehensive and challenging case, which best illustrates the complete concept.

When the UE receives the RRCReconfiguration message including configuration of a CHO (i.e., including a Handover Command and an associated CHO execution condition), the UE does not initiate execution of the handover, but instead remains connected to the serving cell and begins to monitor the configured CHO execution condition (for the indicated candidate target cell). A cell associated with a conditional handover configuration (i.e., a cell which the UE may connect to if the CHO execution condition is fulfilled) may be referred to as a candidate target cell. Similarly, a gNB controlling a cell associated with a conditional handover configuration (i.e., a candidate target cell) may be referred to as a candidate target gNB.

The UE may be configured with multiple candidate target cells. For each candidate target cell, the UE is provided with an associated Handover Command (i.e., an RRCReconfiguration to be applied if/when connecting to the candidate target cell) and an associated CHO execution condition. If/when the CHO execution condition is fulfilled for a candidate target cell, the UE releases the source cell and starts executing the handover towards the candidate target cell (which then becomes the target cell) for which the associated CHO execution condition was fulfilled. From the UE's point of view, the rest of the procedure proceeds like a regular handover procedure, except that the UE discards all CHO configurations when it has successfully connected to the target cell.

On the network side, the serving/source gNB is not aware of if or when a CHO execution condition is fulfilled for the UE, i.e., the UE will silently release the source cell. Therefore, after handover completion, i.e., after successful random access and successful reception of the RRCReconfigurationComplete message (which often is referred to as the Handover Complete message), the target gNB sends a HANDOVER SUCCESS XnAP message to the source gNB. This informs the source gNB that the UE has left the source cell and successfully completed a handover to the target cell. If multiple candidate target gNBs were prepared for CHO for the UE, the source gNB can cancel the CHO preparations in the other (non-selected) candidate target gNBs using the HANDOVER CANCEL XnAP message, so that these gNBs can release any reserved resources.

During a regular handover, the source gNB starts to forward user plane data arriving in the source gNB to the target gNB (for further forwarding to the UE) as soon as the Handover Command is sent to the UE. In CHO, however, due to the uncertainty of if and when the UE will actually execute a handover, it may be suboptimal to start forwarding user plane data to a candidate target gNB upon transmission of the Handover Command, because this will cause unnecessary load on the Xn user plane, as well as processing load in the candidate target gNB. Therefore, the source gNB may choose not to initiate user plane forwarding until it receives the HANDOVER SUCCESS XnAP message from the target gNB. On the other hand, not initiating user plane forwarding until the HANDOVER SUCCESS XnAP message is received delays the availability of buffered downlink data in the target gNB, which increases the handover interruption time. Therefore, both options are available for CHO, referred to as early data forwarding (any time after transmission of the Handover Command and before reception of the HANDOVER SUCCESS XnAP message) and late data forwarding (upon reception of the HANDOVER SUCCESS XnAP message).

The conditional handover procedure is illustrated below by the simplified message diagram in FIG. 4 and the more detailed message diagram in FIG. 5.

FIG. 4 is an example signaling flow illustrating an inter-gNB Conditional Handover message flow in NR. The RRCReconfiguration* indicated with an asterisk (‘*’) is the Handover Command containing the RRC reconfiguration that the UE shall apply if/when connecting to the candidate target gNB in the selected target cell.

The principle for CHO, as defined in 3GPP TS 38.300 Release 17 version 17.1.0, is described in FIG. 5. FIG. 5 is another example signaling flow illustrating inter-gNB Conditional Handover message flow in NR. The RRCReconfiguration message in step 6 is the Handover Command containing the CHO configuration(s). The message diagram is copied from 3GPP TS 38.300 version 17.1.0.

Based on, e.g., a measurement report received from the UE (in a MeasurementReport RRC message), the source node decides to configure the UE for CHO (step 2 in FIG. 5).

The source node prepares one or potentially more candidate target nodes by including a CHO indicator and the current UE configuration in the HANDOVER REQUEST XnAP message sent over Xn (step 3). Unlike a regular (non-CHO) handover, CHO enables the network to prepare the UE with more than one candidate target cell, each candidate target cell with its own target cell configuration (RRCReconfiguration) and its own CHO execution condition. The target cell configuration is generated by the candidate target node while the CHO execution condition is configured by the source node. For CHO in 3GPP Release 16, the CHO execution condition may consist of one or two trigger conditions—the A3 and A5 signal strength/quality based events as defined in 3GPP TS 38.331 version 17.0.0.

As in a regular (non-CHO) handover, the handover command (RRCReconfiguration message) sent to the UE in step 6 is generated by the candidate target node but transmitted to the UE in the source cell by the source node. In case of an inter-node handover (as in FIG. 5Error! Reference source not found.), the handover command is sent from the candidate target node to the source node within the HANDOVER REQUEST ACKNOWLEDGE XnAP message (step 5) as a transparent container (specified as the HandoverCommand inter-node RRC message in 3GPP TS 38.331 version 17.0.0), meaning that the source node does not change the content of the handover command.

The target cell configuration (the RRCReconfiguration for the UE to use in the candidate target cell) and the CHO execution condition for each candidate target cell provided by the network to the UE may collectively be referred to as a CHO configuration, or alternatively, each combination of candidate target cell, target cell configuration and CHO execution condition may be referred to as a CHO configuration (i.e., the terminology is not consistent). When received by the UE in the handover command (RRCReconfiguration message in step 6), the target cell configuration is not applied immediately as in a regular (non-CHO) handover. Instead, the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled to trigger the UE to execute the CHO towards the candidate target cell.

When the CHO execution condition is fulfilled for one of the candidate target cells, the UE releases its source cell connection, applies the associated target cell configuration (RRCReconfiguration) and starts the handover supervision timer T304. The UE now connects to the target node as in a regular handover (step 8). Any CHO configuration stored in the UE is released after completion of the (conditional) handover procedure.

The target node sends the HANDOVER SUCCESS XnAP message over Xn to the source node to inform the source node that the UE has successfully accessed the target cell (step 8a). Triggering of data forwarding to the target node is typically done after receiving the HANDOVER SUCCESS XnAP message in the source node—this is also known as “late data forwarding”. As an alternative, data forwarding may be triggered at an earlier stage in the handover procedure, after receiving the RRCReconfigurationComplete message from the UE (step 7). This mechanism is also known as “early data forwarding”.

If more than one candidate target cell was configured during the Handover Preparation phase, then the source node needs to cancel the CHO for the candidate target cells not selected by the UE. The source node sends the HANDOVER CANCEL XnAP message over Xn on the other signaling connection(s) and/or the other candidate target node(s) to cancel the CHO and thus to initiate a release of the reserved resources in the target node(s) (step 8c).

During a regular (non-CHO) handover, if the handover attempt fails due to, e.g., a radio link failure or expiry of timer T304, the UE will typically perform a cell selection and continue with an RRC re-establishment procedure. But when a CHO execution attempt fails and the selected cell happens to be a candidate target cell included in the CHO configuration, the UE will instead attempt a CHO execution to the selected cell. This UE behavior is however enabled/disabled by means of network configuration.

### Satellite Communication

There is an ongoing resurgence of satellite communications. Several plans for satellite networks have been announced in the past few years. The target services vary, from backhaul and fixed wireless, to transportation, to outdoor mobile, to IoT. Satellite networks may complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP release 15, 3GPP started the work to prepare NR for operation in a non-terrestrial network (NTN). The work was performed within the study item “NR to support Non-Terrestrial Networks” and resulted in 3GPP TR 38.81. In 3GPP release 16, the work to prepare NR for operation in an NTN network continued with the study item “Solutions for NR to support Non-Terrestrial Network”, which has been captured in 3GPP TR 38.821. In parallel the interest to adapt NB-IoT and LTE-M for operation in NTN is growing. As a consequence, 3GPP release 17 contains both a work item on NR NTN and a study item and work item on NB-IoT and LTE-M support for NTN.

A satellite radio access network usually includes the following components: (a) a satellite, which refers to a space-borne platform; (b) an earth-based gateway that connects the satellite to a base station or a core network, depending on the choice of architecture; (c) a feeder link, which refers to the link between a gateway and a satellite; and (d) an access link, or service link, which refers to the link between a satellite and a UE.

Depending on the orbit altitude, a satellite may be categorized as low earth orbit (LEO), medium earth orbit (MEO), or geostationary earth orbit (GEO) satellite. LEO includes typical heights ranging from 250-1,500 km, with orbital periods ranging from 90-120 minutes. MEO includes typical heights ranging from 1,500-35,786 km, with orbital periods, P_{MEO}, in the range 2 hours<P_{MEO}<24 hours. MEO and LEO are also known as a non-geosynchronous orbit (NGSO) type of satellite. GEO includes height at about 35,786 km, with an orbital period of 24 hours, also known as a geosynchronous orbit (GSO) type of satellite.

Two basic architectures can be distinguished for satellite communication networks, depending on the functionality of the satellites in the system. One is the transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE

The second type is regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

FIG. 6 is a network diagram illustrating an example architecture of a satellite network with bent pipe transponders (i.e., the transparent payload architecture). The gNB may be integrated in the gateway or connected to the gateway via a terrestrial connection (wire, optic fiber, wireless link).

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has been traditionally considered as a cell (but a cell consisting of multiple beams is not precluded). The footprint of a beam is also often referred to as a spotbeam. The spotbeam may move over the earth surface with the satellite movement (and the earth's rotation) or may be earth fixed with beam pointing used by the satellite to compensate for its motion. The size of a spotbeam depends on the system design and may range from tens of kilometers to a few thousands of kilometers.

The NTN beam may in comparison to the beams observed in a terrestrial network provide a very wide footprint and may cover an area outside of the area defined by the served cell. Beams covering adjacent cells will overlap and cause significant levels of intercell interference, resulting from the slow decrease of the signal strength in the outwards radial direction. This is due in part to the high elevation angle and long distance to the network-side (satellite-borne) transceiver, which, compared with terrestrial cells, results in a comparatively small relative difference between the distance from the cell center to the satellite and the distance from a point at the cell edge to the satellite. To overcome the large levels of interference, a typical approach in NTN is to configure different cells with different carrier frequencies and polarization modes.

Three types of beams or cells are supported in NTN: (a) Earth-fixed beams/cells provisioned by beam(s) continuously covering the same geographical areas all the time (e.g., in the case of GEO satellites); (b) quasi-Earth-fixed beams/cells provisioned by beam(s) covering one geographic area for a limited period and a different geographic area during another period (e.g., in the case of NGSO satellites generating steerable beams); and (c) Earth-moving beams/cells provisioned by beam(s) whose coverage area slides over the earth surface (e.g., in the case of NGSO satellites generating fixed or non-steerable beams). The terms beam and cell are used interchangeably herein, unless explicitly noted otherwise.

Of the three cell types above, quasi-earth-fixed cells and moving cells seem to be the ones most promising for actual deployment. For moving cells, each cell (the footprint of its beam(s)) moves across the surface of the earth as its serving satellite moves along its orbit. For quasi-earth-fixed cells, the cell area (as the name implies) remains fixed to the same geographical area, regardless of satellite movements. To enable this, a serving satellite dynamically directs its beam(s), so that the same area of the earth is covered despite the satellite's movement. However, because the satellites orbit around the earth, the same satellite will only be able to cover the same area on the earth for a limited time, unless the satellite is in a geostationary orbit (and note that LEO satellites have the most traction in the satellite communication industry). This means that different satellites will have the task of covering a certain geographical cell area at different time periods. When this task is switched from one satellite to another, this in principle means that one cell is replaced by another, although covering the same area. As a consequence, all UEs connected in the old cell (i.e., UEs in RRC_CONNECTED state) are handed over (or otherwise moved, e.g., using RRC connection reestablishment) from the old to the new cell, and UEs camping on the old cell (i.e., UEs in RRC_IDLE or RRC_INACTIVE state) perform cell reselection to the new cell.

In terms of such cell switches there are two alternative principles: 1) hard switch; and 2) soft switch. With hard switch, there is an instantaneous switch from the old to the new cell, i.e., the new cell appears at the same time as the old cell disappears. This makes completely seamless (i.e., interruption free) handover in practice impossible and creates a situation which may lead to overload of the access resources in the new cell, due to potential access attempt peaks when many UEs try to access the new cell right after the cell switch.

With soft switch there is a time period during which the new and the old cell coexist (i.e., overlap), covering the same geographical area. This coexistence/overlap period allows some time for connected UEs to be handed over and for camping UEs to reselect to the new cell, which facilitates distribution of the access load in the new cell and thereby also provides better conditions for handovers with shorter interruption time. Soft switch is likely to be the most prevalent cell switch principle in quasi-earth-fixed cell deployments.

Ephemeris data (sometimes referred to as just “ephemeris”) is data that facilitates a UE (or other entity) to determine a satellite's position and velocity, i.e., the ephemeris data contains parameters related to the satellite's orbit. There are several different formats defined for ephemeris data.

TR 38.821 captures that ephemeris data should be provided to the UE, for example, to assist with pointing a directional antenna (or an antenna beam) towards a satellite, and to calculate a correct timing advance (TA) and Doppler shift. In NR NTN and IoT NTN, ephemeris data may be broadcast in the system information (SI) in each cell, included in an NTN specific SIB, (labeled SIB19 in NR NTN and SIB31 IoT NTN).

A satellite orbit may be fully described using six parameters. Which set of parameters is chosen may be decided by the user and many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis o determine its position in space, and the epoch time t determines a reference time (e.g., the time when the satellites moves through periapsis). This set of parameters is illustrated in FIG. 7.

FIG. 7 illustrates orbital elements comprising parameters included in one ephemeris data format.

As an example of a different parametrization, the two-line elements (TLEs) use mean motion n and mean anomaly M instead of a and t. A different set of parameters is the position and velocity vector (x, y, z, vₓ, v_{y}, v_{z}) of a satellite. These are sometimes referred to as orbital state vectors. They may be derived from the orbital elements and vice versa, because the information they contain is equivalent. All these formats (and many others) are possible choices for the format of ephemeris data to be used in NTN.

An aspect discussed during the 3GPP study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently. For example, the update frequency depends on the satellite and its orbit and ranges from weekly to multiple times a day for satellites on very low orbits which are exposed to strong atmospheric drag and need to perform correctional maneuvers often. Even more frequent updates will be used in NR NTN (and IoT NTN) to facilitate the UE to determine/predict the satellite's position (and velocity) accurately enough to satisfy the requirements in NTN, e.g., to enable a UE to calculate an accurate enough UE-specific TA.

A Global Navigation Satellite System (GNSS) comprises a set of satellites orbiting the earth in orbits crossing each other, such that the orbits are distributed around the globe. The satellites transmit signals and data that allows a receiving device on earth to accurately determine time and frequency references and, maybe most importantly, accurately determine its position, provided that signals are received from a sufficient number of satellites (e.g., four). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System and the European Galileo.

The transmissions from GNSS satellites include signals that a receiving device uses to determine the distance to the satellite. By receiving such signals from multiple satellites, the device can determine its position. However, this requires that the device also knows the positions of the satellites. To enable this, the GNSS satellites also transmit data about their own orbits (from which position at a certain time can be derived). In GPS, such information is referred to as ephemeris data and almanac data (or sometimes lumped together under the term navigation information).

The time required to perform a GNSS measurement, e.g., GPS measurement, may vary widely, depending on the circumstances, mainly depending on the status of the ephemeris and almanac data the measuring devices has previously acquired (if any). In the worst case, a GPS measurement may take several minutes. GPS is using a bit rate of 50 bps for transmitting its navigation information. The transmission of the GPS date, time and ephemeris information takes 90 seconds. Acquiring the GPS almanac containing orbital information for all satellites in the GPS constellation takes more than 10 minutes. If a UE already possesses this information the synchronization to the GPS signal for acquiring the UE position and Coordinated Universal Time (UTC) is a significantly faster procedure. Often, the time to perform a GNSS measurement is described in terms of three different states or starting type of the GNSS receiver:
Hot state: The device remembers its last calculated position and the satellites in view, the almanac used, and the UTC time. It leverages this information to attempt to lock onto the same satellites and calculate a new position. This is the quickest state but, generally, it only works close to the location of the last GNSS measurement.
Warm state: The device remembers its last calculated position, almanac used, and UTC time, but not which satellites were in view. It then performs a reset and attempts to obtain the satellite signals and calculates a new position. The receiver has a general idea of which satellites to look for because it knows its last position and the almanac data helps identify which satellites are visible in the sky.
Cold state: The device does not have any usable previous information. The device attempts to locate satellites, download the almanac, and calculate the new location. This takes the longest time of all states.

A relevant note on terminology is that a position determined based on a GNSS measurement, or the act of determining a position based on a GNSS measurement, is also referred to as a “position fix”.

To handle the timing and frequency synchronization in an NR or LTE based NTN a promising technique is to equip each device with a GNSS receiver. The GNSS receiver allows a device to estimate its geographical position. In one example, an NTN gNB carried by a satellite, or communicating via a satellite, broadcasts its ephemeris data (i.e., data that informs the UE about the satellite's position, velocity, and orbit) to a GNSS equipped UE. The UE may then determine the propagation delay, the delay variation rate, the Doppler shift, and its variation rate based on its own location (obtained through GNSS measurements) and the satellite location and movement (derived from the ephemeris data).

The GNSS receiver also enables a device to determine a time reference (e.g., in terms of Coordinated Universal Time (UTC)) and frequency reference. This may be used for timing and frequency synchronization in an NR or LTE based NTN. In a second example, an NTN gNB carried by a satellite, or communicating via a satellite, broadcasts its timing (e.g., in terms of a UTC timestamp) to a GNSS equipped UE. The UE may then determine the propagation delay, the delay variation rate, the Doppler shift, and its variation rate based on its time/frequency reference (obtained through GNSS measurements) and the satellite timing and transmit frequency.

The UE may use this knowledge to compensate its uplink transmissions for the propagation delay and Doppler effect.

The 3GPP Release 17 SID on NB-IoT and LTE-M for NTN supports this observation. The study assumes GNSS capability in the UE for both NB-IoT and eMTC devices. With this assumption, UE can estimate and pre-compensate timing and frequency offset with sufficient accuracy for uplink transmission. Simultaneous GNSS and NTN NB-IoT/eMTC operation is not assumed.

Furthermore, in the NR NTN work item and IoT NTN work item for 3GPP Release 17, GNSS capability is assumed, i.e., it is assumed that an NR NTN capable or IoT NTN capable UE also is GNSS capable and GNSS measurements at the UEs are essential for the operation of the NTN, e.g., the UEs are expected to compensate their uplink transmissions for the propagation delay and Doppler effect. In particular, the UE uses knowledge of its location and broadcast information about the satellite's position (i.e., ephemeris data) to calculate the UE-satellite round-trip time (RTT), which is then used in UE autonomous calculation of a timing advance (TA), However, an IoT NTN UE is not expected to be able to perform a GNSS measurement while receiving transmissions from network at the same time.

When using GNSS measurements for purposes related to the operation and performance of an NR NTN or IoT NTN, the GNSS measurement must be fresh enough to be reliable. For this reason, the notion of a GNSS validity timer has been introduced, which governs the maximum age UE location information may have when used in such operations (e.g., for calculation of a timing advance and possibly to calculate a frequency adjustment to compensate for the Doppler shift). A suitable value for this maximum age may depend on the UE's implementation, and therefore the GNSS validity timer is a UE implementation specific mechanism. However, the standard specifications include means by which the UE can inform the network (i.e., the serving gNB in NR NTN and the serving eNB in IoT NTN) of the remaining time of the UE's currently running GNSS validity timer.

Propagation delay is an important aspect of satellite communications. Its expected impact in NTN is different from the impacts of propagation delay in a terrestrial mobile system. For a bent pipe satellite network, the UE-gNB round-trip delay may, depending on the orbit height, range from a few or tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | Distance | | One-way | | Propagation |
|---|---|---|---|---|---|---|
| Orbital | Elevation | UE <-> | | propagation | | delay |
| height | angle | satellite | | delay | | difference |
| 600 km | 90° | 600 | km | 2.0 | ms | — |
| | 30° | 1075 | km | 3.6 | ms | 1.6 ms |
| | 10° | 1932 | km | 6.4 | ms | 4.4 ms |
| 1200 km | 90° | 1200 | km | 4.0 | ms | — |
| | 30° | 1999 | km | 6.7 | ms | 2.7 ms |
| | 10° | 3131 | km | 10.4 | ms | 6.4 ms |
| 35786 km | 90° | 35786 | km | 119.4 | ms | — |
| | 30° | 38609 | km | 128.8 | ms | 9.4 ms |
| | 10° | 40581 | km | 135.4 | ms | 16.0 ms |

The propagation delay may also be highly variable due to the high velocity of the LEO and MEO satellites and change in the order of 10-100 μs every second, depending on the orbit altitude and satellite velocity.

The long propagation delays in NTN have many consequences, one of which being that large TA values have to be used (where a TA is the time a UE has to advance its uplink transmission in relation to the corresponding frame, slot and symbol in the downlink to achieve alignment between the uplink and the downlink frame/slot/symbol structure at an uplink/downlink alignment reference point, which typically is the gNB). In addition, due to the fast movement of the satellite (excluding GEO satellites), the TA will continuously change and will do so quite rapidly. 3GPP has dealt with these circumstances through a combination of new parameters and introduction of the principle of UE autonomous adaptation of the TA.

Typically, the network wants the uplink and downlink to be aligned at the gNB receiver, which means that the TA should be equal to the UE-gNB RTT. The UE-gNB RTT can be divided into two parts: the UE-satellite RTT (i.e., the service link RTT) and the gNB-satellite RTT (which is equal to the feeder link RTT assuming that the gateway and the gNB are collocated). The satellite-gNB RTT is equal for all locations in the cell and thus the same for all UEs in the cell, whereas the UE-satellite RTT depends on the UE's location and thus is UE specific.

To take care of the part of the TA that is common for all UEs in the cell, the satellite broadcasts (in the system information, in a new SIB with NTN specific data (SIB19 in NR NTN and SIB31 in IoT NTN)) Common TA information, consisting of a Common TA value, the first time derivative of the Common TA value (denoted as “drift”) and the second time derivative of the Common TA value (denoted as “drift variation”).

The UE specific part of the TA, i.e., the UE-satellite RTT is left to the UE to autonomously calculate. To do this, the UE obtains its own location and the satellite position. The UE may obtain its own location e.g., using GNSS measurements, and the satellite's position (as well as its velocity) may be derived from the ephemeris data broadcast by the gNB (in the same SIB as the Common TA parameters). The ephemeris data and the Common TA parameters are nominally valid at a so-called epoch time, which is also indicated in the same SIB (or, if the epoch time indication is absent in the SIB, the epoch time is assumed to be the end of the SI window in which the SIB was received). Based on the ephemeris data, the UE can predict the satellite's position a certain time into the future, and the first and second time derivatives (i.e., the drift and drift variation parameters) of the Common TA enables the UE to calculate how the Common TA value changes with time.

Furthermore, the broadcast ephemeris data and Common TA parameters have a limited validity time, which is also indicated in the same SIB. The ephemeris data and Common TA parameters the UE uses when calculating the UE specific TA have to be valid, i.e., their validity time must not have expired. The same goes for the UE location information, typically based on a GNSS measurement, the UE uses in the TA calculation (in particular to calculate the UE-satellite RTT).

3GPP has also introduced support for the possibility to place the uplink/downlink alignment reference point at a place other than in the gNB. This support comes in the form of a parameter denoted as Kmac (also referred to as K_mac). The Kmac parameter takes care of the RTT between the gNB and the chosen uplink/downlink alignment reference point. Thus, Kmac=0 means that the uplink/downlink alignment reference point is located in the gNB, while other Kmac values will place the uplink/downlink alignment reference point somewhere between the gNB and the satellite. Kmac is included in the same SIB as the other above mentioned NTN specific configuration parameters. Broadcast of Kmac is optional and absence of a Kmac parameter in the concerned SIB implicitly means that Kmac=0 should be used.

When calculating the UE specific TA, the UE uses the Common TA parameters, the ephemeris data and its own location, i.e., Kmac is not needed for this calculation. However, the UE needs to know Kmac for other purposes, so that it can adapt certain timers to the UE-gNB RTT.

For non-terrestrial networks using 3GPP technology, in particular 5G/NR, the long propagation delay means that the timing advance (TA) the UE uses for its uplink transmissions is essential and has to be much greater than in terrestrial networks in order for the uplink and downlink to be time-aligned at the gNB (or at another point if Kmac>0), as is the case in NR and LTE. One of the purposes of the random access (RA) procedure is to provide the UE with a valid TA. However, even the random access preamble (i.e. the initial message from the UE in the random access procedure) has to be transmitted with a timing advance to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff Chu sequence, and thus another preamble, based on the same Zadoff-Chu root sequence), but this TA does not have to be as accurate as the TA the UE subsequently uses for other uplink transmissions, where the TA has to be accurate enough to keep the timing error smaller than the cyclic prefix (CP).

In conjunction with the random access procedure, the gNB provides the UE with an accurate (i.e., fine-adjusted) TA in the Random Access Response (RAR) message (in 4-step RA) or MsgB (in 2-step RA), based on the time of reception of the random access preamble. In terrestrial NR, the gNB can subsequently adjust the UE's TA using a Timing Advance Command medium access control (MAC) control element (CE) (or an Absolute Timing Advance Command MAC CE), based on the timing of receptions of uplink transmissions from the UE. A goal with such network control of the UE's timing advance is typically to keep the time error of the UE's uplink transmissions at the gNB's receiver within the cyclic prefix (which is required for correct decoding of the uplink transmissions, e.g., on the physical uplink shared channel (PUSCH) and the physical uplink control channel (PUCCH)).

The timing advance control framework for terrestrial NR and LTE also includes a time alignment timer with witch the gNB configures the UE. The time alignment timer is restarted every time the gNB adjusts the UE's TA, and if the time alignment timer expires, the UE is not allowed to transmit in the uplink without a prior random access procedure (which provides the UE with a valid timing advance). These rules associated with the time alignment timer will assumedly be the same in NTN, but the relation and/or interaction between the time alignment timer and certain NTN specific functionality, e.g., related to GNSS measurements, may impact the role of the time alignment timer in NTN. For NTN, 3GPP has also agreed that in addition to the gNB's control of the UE's TA, the UE is allowed to autonomously update its TA based on estimation of changes in the UE-gNB RTT (using the UE's location and broadcast parameters related to the satellite orbit and the feeder link RTT, as previously described).

The long propagation delays and the resulting large TA a UE has to use also impacts the scheduling of uplink transmissions. Specifically, the network has account for the large TA when the network determines the delay to be used between an uplink grant (i.e., a downlink control information (DCI) on the physical downlink control channel (PDCCH) allocating uplink transmission resources for the UE to transmit on) and the uplink transmission resources the uplink grant allocates. For this purpose, a new parameter denoted as “K_{offset}” (or “Koffset” or “K_offset”) is introduced, which is added to the legacy delay, e.g., added to the legacy delay parameter K₂ (or K2) contained in the uplink grant in NR NTN. The K_{offset} parameter comes in two forms: the cell-specific K_{offset}, which is broadcast in the system information and which is common for all UEs in the cell, and the UE-specific K_{offset}, which the network optionally configures for each UE. Configuration of a UE-specific K_{offset} value is optional, and when it is absent, the cell-specific K_{offset} value applies. To facilitate for the network to determine a suitable UE-specific K_{offset} value for a certain UE, a mechanism for TA reporting is introduced in NTN, whereby the UE can report its current TA to the network (where the granularity of the reported TA value is one slot).

Due to the special operating conditions in a non-terrestrial network, the system information broadcast in an NTN cell has to include NTN-specific information. To serve this purpose, a new SIB (SIB19) is introduced in NR NTN which contains NTN-specific information. In IoT NTN, the new SIB31 more or less corresponds to SIB19 in NR NTN.

In 3GPP TS 38.331 version 17.0.0, SIB19 is defined as follows in ASN.1 code:

-- ASN1START
-- TAG-SIB19-START
SIB19-r17 ::= SEQUENCE {

| | | |
|---|---|---|
| ntn-Config | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| ta-Report-r17 | ENUMERATED {enabled} | OPTIONAL, -- Need R |
| lateNonCriticalExtension | OCTET STRING | OPTIONAL, |

...
}
ReferenceLocation-r17 ::= ENUMERATED { ffs } -- FFS
-- TAG-SIB19-STOP
-- ASN1STOP

SIB19 field descriptions

ntn-Config
Provides Ephemeris data, common TA parameters, koffset, validity duration for UL sync
information and epoch time when included in SIB19.
referenceLocation
Reference location of a cell provided via NTN quasi-Earth fixed system. FFS for exact
field description.
ta-Report
Indicates whether UE specific TA reporting is enabled during initial access (see TS
38.321, clause 5.4.8).
t-Service
Indicates the time information on when a cell provided via NTN quasi-Earth fixed system
is going to stop serving the area it is currently covering. The field counts the number of
UTC seconds in 10 ms units since 00:00:00 on Gregorian calendar date 1 Jan. 1900
(midnight between Sunday, Dec. 31, 1899 and Monday, Jan. 1, 1900). FFS “This
field is excluded when determining changes in system information, i.e. changes of t-
Service should neither result in system information change notifications nor in a
modification of valueTag in SIBI.”

Furthermore, the NTN-Config-r17 IE is defined as follows in ASN.1 code in the same specification.

-- ASN1START
-- TAG-NTN-CONFIG-START

| | |
|---|---|
| NTN-Config-r17 ::= | SEQUENCE { |

| epochTime-r17 | EpochTime-r17 | OPTIONAL, -- Need R |
|---|---|---|
| ntn-UlSyncValidityDuration-r17 | ENUMERATED{s5, s10, s15, | |
| | s40, s45, s50, s55, | |
| | s20, s25, s30, s35, | |
| | s40, s45, s50, s55, | |
| | s60, s120, s180, s240} | OPTIONAL, -- Need R |
| cellSpecificKoffset-r17 | INTEGER(0..1023) | OPTIONAL, -- Need R |
| kmac-r17 | INTEGER(0..512) | OPTIONAL, -- Need R |
| ta-Info-r17 | TAInfo-r17 | OPTIONAL, -- Need R |
| ntn-PolarizationDL-r17 | ENUMERATED {rhcp,lhcp,linear} | OPTIONAL, -- Need R |
| ntn-PolarizationUL-r17 | ENUMERATED {rhcp,lhcp,linear} | OPTIONAL, -- Need R |
| ephemerisInfo-r17 | EphemerisInfo-r17 | OPTIONAL, -- Need R |

...
}

| | |
|---|---|
| EpochTime-r17 ::= | SEQUENCE { |

| | |
|---|---|
| sfn-r17 | INTEGER(0..1023), |
| subFrameNR-r17 | INTEGER(0..9) |

}

| | |
|---|---|
| TAInfo-r17 ::= | SEQUENCE { |

| ta-Common-r17 | INTEGER(0..66485757), | |
|---|---|---|
| ta-CommonDrift-r17 | INTEGER(−261935..261935) | OPTIONAL, -- Need R |
| ta-CommonDriftVariant-r17 | INTEGER(0..29470) | OPTIONAL -- Need R |

}
-- TAG-NTN-CONFIG-STOP
-- ASN1STOP

NTN-Config field descriptions

EphemerisInfo
This field provides satellite ephemeris either in format of position and velocity state vector or
in format of orbital parameters. This field is excluded when determining changes in system
information, i.e., changes of XXX should neither result in system information change
notifications nor in a modification of valueTag in SIB1.
epochTime
Indicate the epoch time for assistance information (i.e., Serving satellite ephemeris in IE
ephemerisInfo and Common TA parameters). When explicitly provided through SIB, or
through dedicated signaling, EpochTime is the starting time of a DL sub-frame, indicated by
a SFN and a sub-frame number signaled together with the assistance information. The
reference point for epoch time of the serving satellite ephemeris and Common TA parameters
is the uplink time synchronization reference point. If this field is absent, the epoch time is the
end of SI window where this SIB19 is scheduled. This field is mandatory present when
provided in dedicated configuration.
cellSpecificKoffset
The CellSpecific_K_offset is a scheduling offset used for the timing relationships that need
to be modified for NTN [see TS 38.2xy]. The unit of K_offset is number of slots for a given
subcarrier spacing of 15 kHz.
kmac
K_mac is a scheduling offset provided by network if downlink and uplink frame timing are
not aligned at gNB. It is needed for UE action and assumption on downlink configuration
indicated by a MAC-CE command in PDSCH [see TS 38.2xy]. When UE is not provided by
network with a K_mac value, UE assumes K_mac = 0.
For the reference subcarrier spacing value for the unit of K_mac in FR1, a value of 15 kHz is
used. The unit of K_mac is number of slots for a given subcarrier spacing..
ntn-PolarizationDL
If present, this parameter indicates polarization information for Downlink transmission on
service link: including Right hand, Left hand circular polarizations (RHCP, LHCP) and
Linear polarization.
ntn-PolarizationUL
If present, this parameter indicates Polarization information for Uplink service link.
If not present and ntnPolarizationDL is present, UE assumes a same polarization for UL and
DL.
ntn-UlSyncValidityDuration
A validity duration configured by the network for uplink synchronization assistance
information (i.e., Serving satellite ephemeris and Common TA parameters) which indicates
the maximum time during which the UE can apply assistance information without having
acquired new assistance information.
The unit of ntn-UlSyncValidityDuration is second. This parameter applies to both connected
and idle mode UEs.
ta-Common
TACommon is a network-controlled common timing advanced value and it may include any
timing offset considered necessary by the network. TACommon with value of 0 is supported.
The granularity of TACommon is 4.07 × 10\hat{ }(−3) μs. Values are given in unit of
corresponding granularity. This field is excluded when determining changes in system
information, i.e., changes of XXX should neither result in system information change
notifications nor in a modification of valueTag in SIB1.”
taCommonDrift
Indicate drift rate of the common TA. The granularity of TACommonDrift is 0.2 × 10\hat{ }(−3)
μs/s Values are given in unit of corresponding granularity. This field is excluded when
determining changes in system information, i.e., changes of XXX should neither result in
system information change notifications nor in a modification of valueTag in SIB1.
taCommonDriftVariant
Indicate drift rate variation of the common TA. The granularity of TACommonDriftVariation
is 0.2 × 10\hat{ }(−4) μs/s\hat{ }2. Values are given in unit of corresponding granularity. This field is
excluded when determining changes in system information, i.e., changes of XXX should
neither result in system information change notifications nor in a modification of valueTag in
SIB1.

And the EphemerisInfo IE is defined as follows in ASN.1 code in the same specification.

| -- ASN1START | |
|---|---|
| -- TAG-EPHEMERISINFO-START | |
| EphemerisInfo-r17 ::= | CHOICE { |
| positionVelocity-r17 | PositionVelocity-r17, |
| orbital-r17 | Orbital-r17 |
| } | |
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |
| } | |
| Orbital-r17 ::= | SEQUENCE { |
| semiMajorAxis-r17 | INTEGER (0..8589934591), |
| eccentricityE-r17 | INTEGER (0..524287), |
| periapsis-r17 | INTEGER (0..16777215), |
| longitude-r17 | INTEGER (0..2097151), |
| inclinationI-r17 | INTEGER (−524288..524287), |
| meanAnomalyM-r17 | INTEGER (0..16777215) |

}
PositionStateVector-r17 ::= INTEGER (−3355432..33554431)
VelocityStateVector-r17 ::= INTEGER (−131072..131071)
-- TAG-EPHEMERISINFO-STOP
-- ASN1STOP

EphemerisInfo field descriptions

anomaly
Satellite orbital parameter: Mean anomaly M at epoch time, see NIMA TR 8350.2. Unit in
radian.
Value range 0 . . . 2π by step of 2π * 2⁻²⁴. Actual value = IE value * (2 * π * 2⁻²⁴).
eccentricity
Satellite orbital parameter: eccentricity e, see NIMA TR 8350.2.
Value range 0 . . . 0.015 by step of 0.015 * 2⁻¹⁹. Actual value = IE value * (0.015 * 2⁻¹⁹).
inclination
Satellite orbital parameter: inclination i, see NIMA TR 8350.2. Unit in radian.
Value range −π/2 . . . π/2 by step of π/2 * 2⁻¹⁹. Actual value = IE value * ((π/2) * 2⁻¹⁹).
longitude
Satellite orbital parameter: longitude of ascending node Ω, see NIMA TR 8350.2. Unit in
radian.
Value range 0 . . . 2π by step of 2π * 2⁻²¹. Actual value = IE value * (2 * π * 2⁻²¹).
periapsis
Satellite orbital parameter: argument of periapsis ω, see NIMA TR 8350.2. Unit in radian.
Value range 0 . . . 2π by step of 2π * 2⁻²⁴. Actual value = IE value * (2 * π * 2⁻²⁴).
positionX, positionY, positionZ
X, Y, Z coordinate of satellite position state vector in ECEF. Unit in meter.
Value range −42200000 . . . 42200000 by step of 1.3. Actual value = IE value * 1.3.
semiMajorAxis
Satellite orbital parameter: semi major axis α, see NIMA TR 8350.2. Unit in meter.
Value range 6500000 . . . 43000000 by step of 2⁻³³. Actual value = 6500000 + (43000000 −
6500000) * IE value * 2⁻³³.
velocityVX, velocityVY, velocityVZ
X, Y, Z coordinate of satellite velocity state vector in ECEF. Unit in meter/second.
Value range −8000 . . . 8000 by step of 0.06. Actual value = IE value * 0.06.

Connected mode mobility challenges have been studied in the NTN study item phase for 3GPP Release 16 and are reported in the technical report 3GPP TR 38.821. Two of the challenges discussed in the Technical Report are frequent and unavoidable handovers (e.g., due to feeder link switch or cell switch in a quasi-earth-fixed cell deployments) and handover of a large number of UEs, both of which could result in significant control plane overhead and frequent service interruptions.

This issue is perhaps most pronounced in the quasi-earth-fixed cell scenario when a geographic area is covered by a satellite (serving a cell covering the geographic area) for a limited time period while being replaced by a new satellite (serving a new cell covering the same geographic area) during the next time period, and so on. When the satellite covering the geographic area is replaced, the cell is also replaced, meaning that all the UEs connected in the old cell have to be handed over to the new cell, which potentially results in a high control signaling peak, because all the handovers have to occur in conjunction with the cell replacement (i.e., cell switch).

Hard and soft cell switch have been discussed in 3GPP, with preference for the soft switch case, wherein the old and the new cell both (simultaneously) cover the geographic area during a short overlap period, to simplify handovers with low interruptions.

To mitigate the expected signaling overhead at frequent handovers for a large number of UEs, 3GPP agreed to introduce support for conditional handover (CHO) for NTN in 3GPP Release 17 with the CHO procedure and the trigger conditions as defined for NR in 3GPP Release 16 as a baseline.

In terrestrial networks, a UE can typically determine that it is near a cell edge by detecting a clear difference in the received signal strength (e.g., by performing reference signal receive power (RSRP)-based measurements) compared to the received signal strength at the cell center. In NTN deployments on the other hand, the difference in signal strength between the cell center and the cell edge is typically smaller. That is, the signal strength decreases slowly with the distance from the cell center (much smaller than in a typical terrestrial cell). This is often described as a “flat signal strength” or a “flat RSRP”. Thus, a UE may experience a small difference in signal strength between two beams (e.g., representing two cells) in a region of overlap. This may lead to suboptimal UE behaviors such as repetitive handovers (“ping-pong handovers”) back and forth between the two cells.

To avoid an overall reduction in handover robustness, 3GPP agreed to introduce the following trigger conditions (apart from the already existing trigger conditions, the A3 and A5 CondEvents) for CHO in NTN. One is a new time-based trigger condition, defining a time period, or a time window, when the UE may execute CHO to a candidate target cell. Another is a new location-based trigger condition, defining a first distance threshold for the distance from the UE to a reference location in the source cell and a second distance threshold for the distance from the UE to a reference location in a candidate target cell, based on which the UE may trigger and execute CHO. Also, reuse of the existing A4 event (neighbor becomes better than threshold) as defined in 3GPP TS 38.331 version 17.0.0, i.e., an A4 CondEvent is introduced.

The time-based trigger condition is defined by 3GPP as the time period [T1, T2] associated with each candidate target cell, where T1 is the starting point of the time period represented by a Coordinated Universal Time (UTC) and T2 is the end point of the time period represented by a time duration or a timer value, e.g., 10 seconds.

In 3GPP TS 38.331 version 17.0.0, the time-based condition (condEventT1-r17) is defined in ASN.1 in the ReportConfigNR IE as shown below:

| | |
|---|---|
| condEventT1-r17 | SEQUENCE { |
| t1-Threshold-r17 | INTEGER (0..549755813887), |
| duration-r17 | INTEGER (1..6000) |

}

The duration encoded by the duration-r17 field indicates steps of 100 ms (i.e., it ranges from 100 ms to 10 minutes). It should be counted as starting from T1, which means that in principle T2=T1+duration=t1-Threshold-r17+duration-r17.

3GPP further agreed that the time-based trigger condition may only be configured in the UE in combination with one of the signal strength/quality based CondEvents A3, A4 or A5. This implies that the UE may only perform CHO to the candidate target cell in the time window defined by T1 and T2 if the signal strength/quality-based event is fulfilled within this time frame. The time-based condition AND the signal strength/quality-based condition must thus be fulfilled simultaneously for the UE to execute the CHO.

In 3GPP, discussions are still ongoing what the UE is supposed to do with the CHO configuration when the CHO execution condition has not been fulfilled (i.e., when CHO has not been triggered) for the candidate target cell when the time window expires, i.e., at the time T2.

Two alternatives have been discussed so far. In one alternative, the UE discards the CHO configuration for the associated candidate target cell after T2. In another alternative, the UE may keep the CHO configuration for the associated candidate target cell after T2. The CHO configuration may then be used in a potential recovery procedure, e.g., caused by a radio link failure (RLF) in the source cell followed by a cell selection (as the first action of an RRC connection re-establishment procedure), similar to the 3GPP Release 16 UE behavior.

In addition to the time-based condition, 3GPP has also agreed to specify a location-based condition for CHO execution. The location-based condition is fulfilled if the UE's distance to a reference location of the serving (source) cell (assumedly representing the center of the serving/source cell) exceeds a first threshold while the distance to a reference location of a candidate target cell (assumedly representing the center of the candidate target cell) goes below a second threshold. Like the time-based condition, the location-based condition will be combined with one of the signal strength/quality-based CondEvents A3, A4 or A5, and both the location-based condition and the signal strength/quality-based condition have to be fulfilled for the CHO execution to be triggered.

The non-terrestrial network described above is based on 5G/NR technology adapted for communication via satellites. An NTN standard for IoT, denoted as “IoT NTN”, is also being specified in Release 17 of the 3GPP standards. IoT NTN is based on the LTE NB-IoT technology adapted for communication via satellites. To distinguish NTN based 5G/NR technology from IoT NTN, NTN based on 5G/NR technology is often referred to as “NR NTN”. In light of these distinctions, depending on the context, the term “NTN” is sometimes used to refer to either or both of NR NTN and IoT NTN, and sometimes the term “NTN” is used to refer only to NR NTN.

There currently exist certain challenges. For example, when a UE is to be handed over to a NTN cell, a problem is that the source/serving gNB does not know if the UE has a valid GNSS measurement, nor does it know how long it would take for the UE to get a valid GNSS measurement result if the UE does not have one. As a result, if the UE does not have valid (up to date) information about its location, e.g., a fresh/valid GNSS measurement result, the handover may fail, e.g., due to expiration of the handover supervision timer T304, while the UE is performing a GNSS measurement (or after the UE has concluded a GNSS measurement with too little time left of T304 to execute the handover).

The problem is particularly pronounced in conjunction with handover from a terrestrial cell to a NTN cell, because a UE does not regularly perform GNSS measurements, or otherwise keeps its location information up to date while connected in a terrestrial cell.

### SUMMARY

As described above, certain challenges currently exist with location information for mobility in a non-terrestrial network (NTN). Certain aspects of the present disclosure and their embodiments may provide solutions to these or other challenges. For example, in particular embodiments a user equipment (UE) may provide information about its Global Navigation Satellite System (GNSS) status to the network (e.g., represented by a gNB or an eNB), and the network may use the information when preparing a handover. The GNSS status information may, e.g., comprise information about availability or lack of availability of valid UE location information (typically obtained through GNSS measurement) in the UE, GNSS measurement state, the time since the last GNSS measurement (or the time when GNSS was last measured), the remaining amount of time that the UE's location information is valid, and/or estimated time T to acquire valid location information through GNSS measurement (where T=0 means that valid location information is already available in the UE).

In some embodiments, a UE includes GNSS status information in a message conveying radio resource management (RRM) measurement results to the network, e.g., to a serving radio access network (RAN) node, e.g., a gNB serving the UE, e.g., in a MeasurementReport Radio Resource Control (RRC) message. The RAN node receiving the MeasurementReport message may use this information to derive an estimation of how long time, T, the UE will need to acquire valid (and reliable) information about its own location.

Furthermore, if the measurement results in the MeasurementReport message implies that a handover of the UE to a neighbor cell would be beneficial (i.e., the MeasurementReport message triggers a handover decision in the RAN node), the serving RAN node (also acting as the source RAN node in the handover procedure) ensures that the handover supervision timer, T304, is set to a long enough time to allow the UE to perform the GNSS measurement before accessing the target cell.

As one option, for an inter-RAN node handover, the serving/source RAN node sends T to the selected target RAN node in the HANDOVER REQUEST XnAP message (or the HANDOVER REQUEST X2AP message for LTE). The target RAN node may then configure the T304 timer accordingly in the HandoverCommand (e.g., the “regular” T304 time plus T) and send it to the source RAN node in the HANDOVER REQUEST ACKNOWLEDGE XnAP message (or the HANDOVER REQUEST ACKNOWLEDGE X2AP message in LTE). The source RAN node then forwards the content of the HandoverCommand as an RRCReconfiguration message to the UE to trigger a handover. The UE performs the GNSS measurement and then proceeds with the handover execution.

The GNSS status information may, e.g., comprise information about availability or lack of availability of valid UE location information (typically obtained through GNSS measurement) in the UE, GNSS measurement state, the time since the last GNSS measurement (or the time when GNSS was last measured), the remaining amount of time that the UE's location information is valid, and/or estimated time T to acquire valid location information through GNSS measurement (where T=0 means that valid location information is already available in the UE).

According to some embodiments, a method is performed by a wireless device. The method comprises obtaining GNSS location information associated with the wireless device and transmitting a status of the GNSS location information to a network node.

The status may comprise a remaining amount of time that the GNSS location information is valid. The status may comprise any one or more of: availability or lack of availability of valid GNSS location information, GNSS measurement state, a time since a last GNSS measurement, and a time T to acquire valid GNSS location information.

In particular embodiments, the GNSS measurement state comprises a starting type of a GNS receiver. The starting type comprises an indication of an amount of usable data from a previously acquired GNSS measurement. For example, the starting type may comprise one of a hot start, a warm start, and a cold start.

In particular embodiments, transmitting the status of the GNSS location information to a network node comprises transmitting the status in a measurement report (e.g., radio resource control (RRC) message).

In particular embodiments, upon transmitting the indication of the status to the network node, the method comprises performing a GNSS measurement procedure.

In particular embodiments, the method further comprises receiving an indication from the network node to perform a GNSS measurement procedure and performing the GNSS measurement procedure.

In particular embodiments, the method further comprises receiving an indication to perform a mobility procedure from the network node. A target of the mobility procedure is a NTN cell. The method further comprises performing a GNSS measurement procedure and performing the mobility procedure to the NTN. Performing the mobility procedure to the NTN cell may comprise determining a timing advance based on the GNSS measurement.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a first network node (e.g., a source network node). The method comprises receiving a status of GNSS location information associated with a wireless device from the wireless device and performing a mobility operation for the wireless device based on the status of the GNSS location information.

In particular embodiments, the status comprises a remaining amount of time that the GNSS location information is valid. The status may comprise any one or more of availability or lack of availability of valid GNSS location information, GNSS measurement state, a time since a last GNSS measurement, and a time T to acquire valid GNSS location information.

In particular embodiments, receiving the status of the GNSS location information from the wireless device comprises receiving the status in a measurement report (e.g., RRC message).

In particular embodiments, based on the status of the GNSS location information, the method comprises determining an amount of time T for the wireless device to obtain a valid GNSS measurement. The method may further comprise transmitting the time T to a second network node (e.g., a target network node) and receiving from the second network node a configuration for a mobility procedure for the wireless device. The configuration is based on the time T.

In particular embodiments, the method further comprises transmitting an indication to perform a mobility procedure to the wireless device. The indication to perform the mobility procedure comprises a configuration based on the time T.

In particular embodiments, the method further comprises transmitting an indication to perform a GNSS measurement procedure to the wireless device.

In particular embodiments, the mobility procedure comprises a mobility procedure to a NTN cell.

According to some embodiments, a method is performed by a second network node (e.g., a target network node). The method comprises receiving a status of GNSS location information associated with a wireless device from a first network node (e.g., a source network node) and transmitting a mobility procedure configuration for the wireless device based on the status of the GNSS location information to the first network node.

In particular embodiments, the second network node comprises a network node of a NTN.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments may avoid handover failures, even when the UE that is subject to the handover has to perform a GNSS measurement (and irrespective of the GNSS measurement state the UE starts from) prior to accessing the target cell.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is an example signaling flow for an Xn-based inter-gNB handover in New Radio (NR);

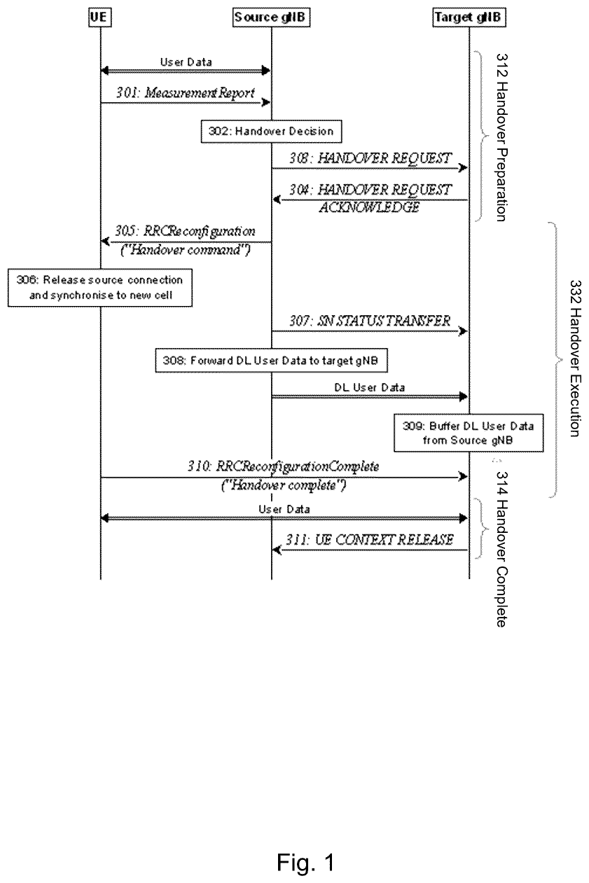

FIG. 2 is another example signaling flow for an Xn-based inter-gNB handover in NR;

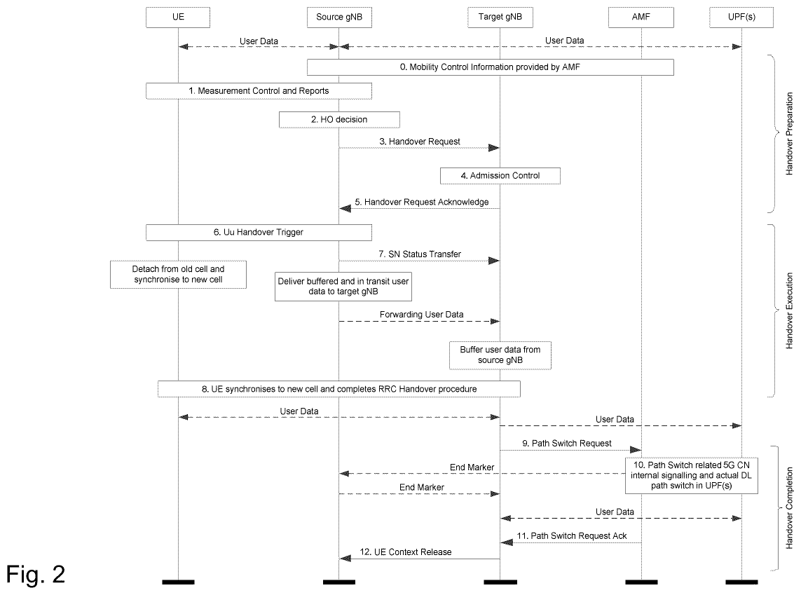

FIG. 3 includes two flow diagrams illustrating two error cases addressed by conditional handover (CHO);

FIG. 4 is an example signaling flow illustrating an inter-gNB Conditional Handover message flow in NR;

FIG. 5 is another example signaling flow illustrating an inter-gNB Conditional Handover message flow in NR;

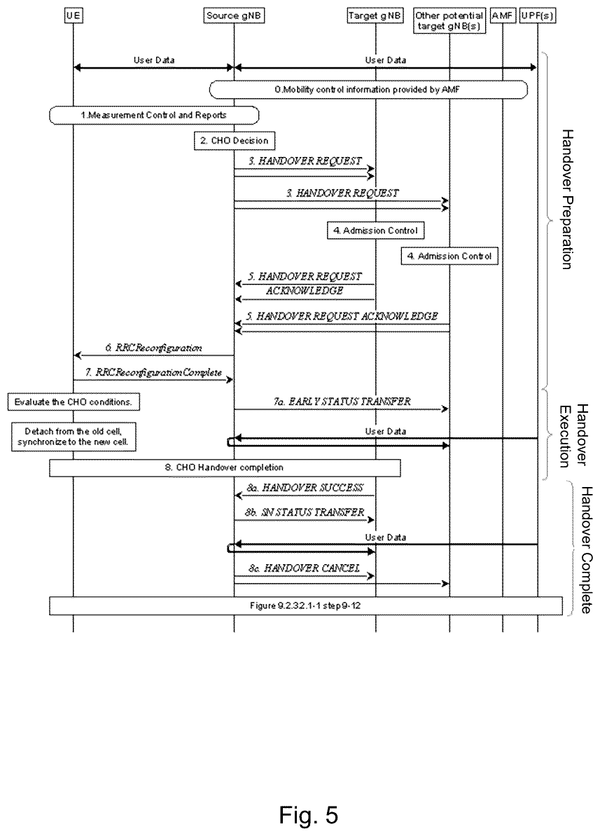

FIG. 6 is a network diagram illustrating an example architecture of a satellite network with bent pipe transponders;

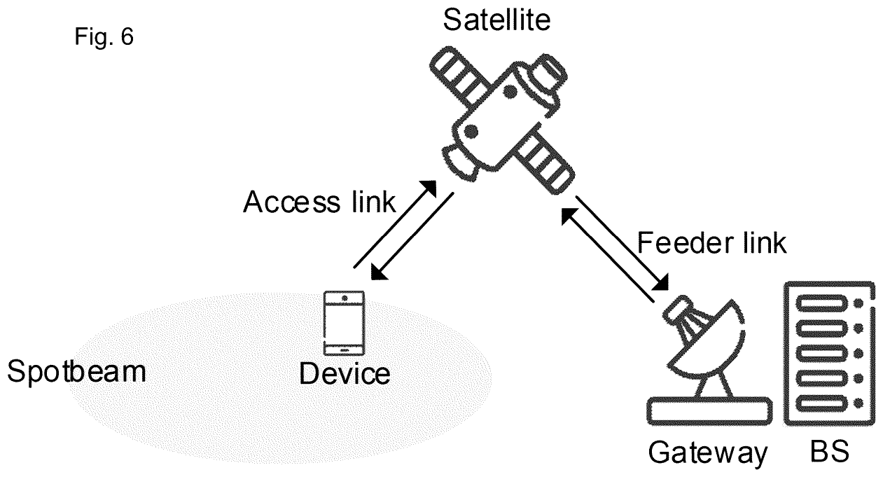

FIG. 7 illustrates orbital elements comprising parameters included in one ephemeris data format;

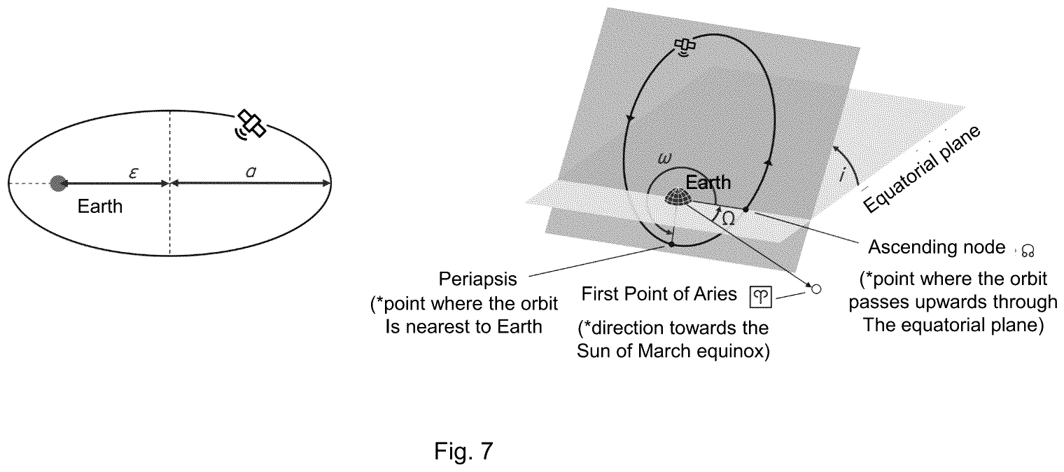

FIG. 8 illustrates an example communication system, according to certain embodiments;

FIG. 9 illustrates an example user equipment (UE), according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method performed by a wireless device, according to certain embodiments;

FIG. 15A illustrates a method performed by a source network node, according to certain embodiments; and

FIG. 15B illustrates a method performed by a target network node, according to certain embodiments.

### DETAILED DESCRIPTION

As described above, certain challenges currently exist with location information for mobility in a non-terrestrial network (NTN). Certain aspects of the present disclosure and their embodiments may provide solutions to these or other challenges. For example, in particular embodiments a user equipment (UE) may provide information about its Global Navigation Satellite System (GNSS) status to the network (e.g., represented by a gNB or an eNB), and the network may use the information when preparing a handover.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As used herein, the term non-terrestrial network may, depending on the context, refer to either or both of New Radio (NR) NTN and Internet of things (IoT) NTN, and sometimes the term is used to refer to only NR NTN.

The embodiments outlined below are described mainly in terms of NR based NTNs, but they are equally applicable in an NTN based on Long Term Evolution (LTE) technology (and in particular IoT NTN).

The term “network” is used herein to refer to a network node, which typically will be a RAN node such as a gNB (e.g., in a NR based NTN) or an eNB (e.g., in an LTE based NTN, such as an IoT NTN), but which may also be a base station or an access point in another type of network, or any other network node with the ability to directly or indirectly communicate with a UE. Refinements with finer granularity are also conceivable. For example, a gNB may be an en-gNB, and if a split gNB architecture is applied (dividing the gNB into multiple separate entities or notes), the term “node” may refer to a part of the gNB, such as a gNB-CU (often referred to as just central unit (CU)), a gNB-DU (often referred to as just distributed unit (DU)), a gNB-CU-CP or a gNB-CU-UP. Similarly, an eNB may be an ng-eNB, and if a split eNB architecture is applied (dividing the eNB into multiple separate entities or notes), the term “network” (and the network node it implies) may refer to a part of the eNB, such as an eNB-CU, an eNB-DU, an eNB-CU-CP or an eNB-CU-UP. Furthermore, the term “network” (and the network node it implies) may also refer to an integrated access and backhaul (IAB)-donor, IAB-donor-CU, IAB-donor-DU, IAB-donor-CU-CP, or an IAB-donor-CU-UP.

The term “RAN node” is often used herein. It typically refers to a gNB (e.g., in a NR based NTN) or an eNB (e.g., in an LTE based NTN, such as an IoT NTN), but it may also be any other kind of RAN node, such as a base station or an access point in another type of RAN node with the ability to directly or indirectly communicate with a UE. Refinements with finer granularity are also conceivable. For instance, a gNB may be an en-gNB, and if a split gNB architecture is applied (dividing the gNB into multiple separate entities or notes), the term “RAN node” or “node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the eNB into multiple separate entities or notes), the term “RAN node” or “node” may refer to a part of the eNB, such as an eNB-CU, an eNB-DU, an eNB-CU-CP or an eNB-CU-UP. Furthermore, the term “RAN node” may also refer to an IAB-donor, IAB-donor-CU, IAB-donor-DU, IAB-donor-CU-CP, or an IAB-donor-CU-UP.

Herein, the terms “location” and “position” are used interchangeably.

At least some of the terms “source node”, “target node” and “candidate target node”, or “source RAN node”, “target RAN node” and “candidate target RAN node”, are sometimes used herein. The “node”, or “RAN node”, in these terms should be understood as typically being a RAN node in a NTN based on NR technology, LTE technology or any other radio access technology (RAT) in which handover, conditional handover or another mobility or conditional mobility concept is defined. In an NR based NTN, such a RAN node may be assumed to be a gNB. In an LTE based NTN (including an IoT NTN), such a RAN node may be assumed to be an eNB. Alternatives to, or refinements of, these interpretations are however also conceivable. For example, a gNB may be an en-gNB, and if a split gNB architecture is applied (dividing the gNB into multiple separate entities or notes), the term “node” or “RAN node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the eNB into multiple separate entities or notes), the term “node” or “RAN node” may refer to a part of the eNB, such as an eNB-CU, an eNB-DU, an eNB-CU-CP or an eNB-CU-UP. Furthermore, the “node”, or “RAN node”, in the terms may also refer to an IAB-donor, IAB-donor-CU, IAB-donor-DU, IAB-donor-CU-CP, or an IAB-donor-CU-UP.

When conditional handover (CHO) is configured for a UE, a cell which the UE potentially can connect to (i.e., if the CHO execution condition is fulfilled for the cell) is denoted as “candidate target cell”. Similarly, a RAN node controlling a candidate target cell is denoted as “candidate target node” or “candidate target RAN node”. However, once the UE has detected a fulfilled CHO execution condition for a candidate target cell, this terminology becomes a bit blurred. At this point, during the actual execution of the CHO and when the UE has connected to the new cell, the concerned cell may be referred to as either a “candidate target cell” or a “target cell”. Similarly, a RAN node controlling such a cell, may in this situation be referred to as either a “candidate target node” (or “candidate target RAN node”) or a “target node” (or “target RAN node”).

A condition included in a CHO configuration governing the execution of the conditionally configured procedure may be referred to as a CHO execution condition, a handover (HO) execution condition, a CHO trigger condition, a HO trigger condition or sometimes just a trigger condition or an execution condition. Furthermore, phases of the procedure may be referred to as the Handover Preparation phase, the Handover Execution and/or the Handover Completion phase, or may be referred to as the Conditional Handover Preparation phase (or the (conditional) Handover Preparation phase), the Conditional Handover Execution phase and/or the Conditional Handover Completion phase.

The target cell configuration (the RRCReconfiguration for the UE to use in the candidate target cell) and the CHO execution condition for each candidate target cell provided by the network to the UE may collectively be referred to as a CHO configuration, or, alternatively, each combination of candidate target cell, target cell configuration and CHO execution condition may be referred to as a CHO configuration (i.e., the terminology is not consistent).

The terms “Handover Command” and “HandoverCommand” are used interchangeably herein. Both terms refer to a UE configuration the target node (of a regular handover) or candidate target node (of a conditional handover), during the (conditional) handover preparation phase, compiles for the UE to be subject to the handover or conditional handover. This UE configuration is compiled in the form of an RRCReconfiguration message which is conveyed to the UE via the source node. The RRCReconfiguration is associated with a certain target cell or candidate target cell and the UE applies the RRCReconfiguration when/if it accesses the concerned (candidate) target cell controlled by the (candidate) target node. Formally, “HandoverCommand” is an RRC inter-node message which is conveyed from a target node or a candidate target node to a source node during the preparation of a handover or a conditional handover. It is carried by the HANDOVER REQUEST ACKNOWLEDGE XnAP in the Target NG-RAN node To Source NG-RAN node Transparent Container information element (IE). The “HandoverCommand” RRC inter-node message contains an RRCReconfiguration the UE should apply when accessing the target cell or candidate target cell. The source node forwards this RRCReconfiguration (i.e., the HandoverCommand) to the UE. In this solution description, the term “HandoverCommand” is also used to denote this RRCReconfiguration when it is stored in a UE as a part of a CHO configuration. This is also called the condRRCReconfig-r16 IE in the CondReconfigToAddMod-r16 IE (which contains the CHO configuration).

Some embodiments are described in terms of handover, but they are equally applicable to other mobility procedures in RRC_CONNECTED state, such as PSCell addition, PSCell change, SCell addition, conditional handover (CHO), conditional PSCell addition and conditional PSCell change.

The term “satellite” is sometimes used in the description of embodiments and examples, but the embodiments and examples apply also to a high-altitude pseudo-satellite (HAPS), thus “satellite” is sometimes used with the meaning “satellite or HAPS”.

The term “terrestrial cell” refers to a cell in a terrestrial network.

A UE can use information about its own location in combination with ephemeris and Common TA parameters to calculate a TA to use for transmission in a cell served by the satellite which the ephemeris and Common TA parameters pertain to. It is also feasible for a UE to calculate a frequency adjustment (to compensate for the Doppler shift) based on information about its own location in combination with ephemeris parameters, where the UE may apply the frequency adjustment when transmitting in a cell served by the satellite which the ephemeris parameters pertain to.

Particular embodiments are described with respect to scenarios of UE mobility in RRC_CONNECTED state, e.g., handover, where the target node of the mobility procedure is a cell in a non-terrestrial network. A primary target scenario is where the source cell of the mobility procedure is a cell in a terrestrial network, because a UE is not expected to maintain valid location information, e.g., to regularly perform GNSS measurements, while connected in a cell in a terrestrial network, but scenarios where the source cell of an RRC_CONNECTED state mobility procedure is a cell in a non-terrestrial network are also relevant, as long as the target cell is a cell in a non-terrestrial network.

In particular embodiments, a UE provides information about its GNSS status to the network (e.g., represented by a gNB or an eNB), and the network may use the information when preparing a handover. The GNSS status information may, e.g., comprise information about availability or lack of availability of valid UE location information (typically obtained through GNSS measurement) in the UE, GNSS measurement state, the time elapsed since the last GNSS measurement (or the time when GNSS was last measured), the remaining amount of time that the UE's location information is valid (e.g., remaining GNSS validity time or the time when the UE will consider the UE location as invalid), and/or estimated time T to acquire valid location information through GNSS measurement (where T=0 means that valid location information is already available in the UE). The term “GNSS measurement state” refers to the state of a UE needs with respect to receiving various auxiliary information from GNSS satellite(s) to be able to derive a position from the signals received from GNSS satellites, and the UE may be in different states when it comes to the acquisition of the auxiliary information (e.g., hot, warm and cold states), which in turn impacts the time duration the UE needs to acquire location information using GNSS measurements.

In some embodiments, a UE includes GNSS status information in a message conveying RRM measurement results to the network, e.g., to a serving RAN node, e.g., a gNB serving the UE, e.g., in a MeasurementReport RRC message. The RAN node receiving the message may use the GNSS status information to determine whether the UE will need to acquire the UE location (e.g. by performing a GNSS measurement) and/or to derive an estimation of a time duration, T, the UE will need to acquire valid (and reliable) information about its own location (if the information from the UE contained an explicit estimate of the time required to acquire location information through a GNSS measurement, the derivation may be trivial and basically no action may be needed). Furthermore, if the measurement results in the MeasurementReport message implies that a handover of the UE to a neighbor cell would be beneficial (i.e., the MeasurementReport message triggers a handover decision in the RAN node), the serving RAN node (also acting as the source RAN node in the handover procedure), in some embodiments, ensures that the handover supervision timer, T304, is set to a long enough time to allow the UE to perform the GNSS measurement before accessing the target cell.

As one option, for an inter-RAN node handover, the serving/source RAN node sends T to the selected target RAN node in the HANDOVER REQUEST XnAP message (or the HANDOVER REQUEST X2AP message for LTE). The target RAN node may then configure the T304 timer accordingly in the HandoverCommand (e.g., the “regular” T304 time plus T) and send it to the source RAN node in the HANDOVER REQUEST ACKNOWLEDGE XnAP message (or the HANDOVER REQUEST ACKNOWLEDGE X2AP message). The source RAN node may then forward the content of the HandoverCommand as an RRCReconfiguration message to the UE to trigger a handover.

The UE performs the GNSS measurement and then proceeds with the handover execution, i.e., acquiring downlink synchronization in the target NTN cell (unless this was already done) and initiating the random access procedure in the target NTN cell.

As a further option, the target RAN node may choose to delay its reservation of resources for the UE to be handed over, e.g., delay it until after a duration equal to T. Another option is an NG-based handover procedure, i.e., the corresponding procedure but using the NG-C interface and NGAP messages (or an S1-based handover procedure, i.e., the corresponding procedure but using the S1 interface and S1AP messages for LTE).

As an alternative way to leverage the derived time T, in some embodiments, when the serving RAN node has received the MeasurementReport message with the GNSS status information (and derived T from it), the serving RAN node waits for a duration of T until it initiates the handover preparation procedure. A disadvantage of this approach is that while the serving RAN node is waiting, the channel quality in the serving cell may deteriorate and become bad enough that the transmission of the RRCReconfiguration message to trigger the handover fails.

Another alternative, which suffers from the same disadvantage, is that when the serving RAN node has received the MeasurementReport message (which may imply that a handover of the UE would be beneficial) with the GNSS status information, unless the GNSS status information indicates that the UE has valid UE location information (i.e., typically a fresh enough GNSS measurement result), the serving RAN node instructs the UE to perform a GNSS measurement (and, if needed, the serving RAN node configures a GNSS measurement gap for the GNSS measurement), e.g., using an RRC message or a MAC message (e.g., a MAC CE), or in some embodiments a DCI message on the PDCCH. As one option, the serving RAN node may then wait for a duration of T, or until the UE indicates that the GNSS measurement has been performed, before the serving RAN node initiates the handover preparation procedure. As another option, the instruction to the UE to perform a GNSS measurement also comprises—implicitly or explicitly—that the UE, upon conclusion of the GNSS measurement, should send another MeasurementReport message (containing new measurement results), and if this MeasurementReport message implies that a handover is (or is still) beneficial, the serving RAN node initiates the handover preparation procedure. Note that for this second MeasurementReport message, the UE may disregard previous reporting configurations in terms of event triggers or reporting periodicity.

In the above embodiments, the UE may be configured to start location information acquisition, i.e., typically by performing a GNSS measurement, when it sends the MeasurementReport message or, optionally for an event-triggered MeasurementReport message, when the RRM report (i.e., the sending of the MeasurementReport message) is triggered (i.e., when the trigger-event is fulfilled), if the UE at that time does not have valid information about its own location. Because a MeasurementReport message, especially an event-triggered MeasurementReport message, often triggers the receiving RAN node to initiate a handover procedure for the UE that sent the MeasurementReport message, this feature may decrease the time until the UE has valid information about its own location (and thus is prepared to (based on the UE location information an ephemeris and Common TA parameters) calculate a TA (and frequency adjustment if applicable) to use when accessing the target cell of a handover). Thus, the delay until a handover is executed and/or the duration of the communication interruption during a handover may be decreased.

In the above embodiments, the UE may be configured to include the GNSS status information in the MeasurementReport message. As one option, this may be configured in the ReportConfigNR IE, and as another option, it may be configured in the MeasObjectNR IE. Other configuration options, e.g., using a new IE, are not precluded.

The above embodiments are relevant when the MeasurementReport message triggers a handover decision in the RAN node (e.g., the measurement results in the MeasurementReport message implies that a handover would be beneficial). Thus, the above embodiments are relevant when the reporting configuration governing when the UE sends the MeasurementReport message(s) includes an event-triggered reporting condition (where the event is chosen such that when it is fulfilled, this implies that a handover of the UE may be beneficial).

In an intra-RAN node handover case (i.e., handover between two cells controlled by the same RAN node (e.g., the same gNB or the same eNB), the procedures become simplified, because the inter-RAN node messaging is replaced by (at least partly) proprietary RAN node internal communication.

In some embodiments, the configuration of the UE's behavior with regards to inclusion of the GNSS status information in the MeasurementReport message, whether it is configured in the ReportConfigNR IE, the MeasObjectNR IE, or using some other means, may include a condition for when the UE is to include the GNSS status information in the MeasurementReport message. Such a condition may, e.g., be that no valid location information is available in the UE, or, as another option, that no valid location information is available in the UE and the UE will need a time period exceeding a configured threshold to obtain it. Another condition may be that the MeasurementReport message contains result(s) of measurement(s) on NTN specific frequencies.

In a variation of the previously described embodiments, the UE sends the GNSS status information on request from the network, e.g., the serving RAN node (e.g., the serving gNB or the serving eNB), wherein this request from the network optionally may have been triggered by a MeasurementReport message from the UE, e.g., including measurement data implying that a handover of the UE may be beneficial. The request may have the form of, e.g., a new RRC message or an existing RRC message such as a UEInformationRequest message, or a MAC message (e.g., anew MAC CE). The GNSS status may thus be sent in a message separate from the MeasurementReport message, e.g., a new RRC message or a second MeasurementReport message or a UEInformationResponse message (in which case the request message may be a UEInformationRequest message), or a MAC message (e.g., a new MAC CE).

In another variation of the previously described embodiments, the UE includes basic GNSS status information (e.g., an indication of whether valid UE location information (assumedly obtained through a sufficiently recent GNSS measurement) is available or is not available in the UE) in the MeasurementReport message, and then the network requests more (using a new RRC message or an existing RRC message such as a UEInformationRequest message, or a MAC message (e.g., a new MAC CE)) more details, such as the estimated time required to obtain valid location information, e.g., to perform a GNSS measurement. The UE may then provide the additional details in anew RRC message or a secondMeasurementReport message or a UEInformationResponse message (in which case the request message may be a UEInformationRequest message), or a MAC message (e.g., a new MAC CE).

In some embodiments, the serving RAN node may take the derived time period T into account when configuring a conditional mobility procedure, e.g., a conditional handover, for the concerned UE, e.g., by adapting a time-based CHO execution condition accordingly, so that end of the time period defined by the time-based CHO execution condition (i.e., T2) does not occur before the expiration of the time T.

In a generalization of any or all of the embodiments herein, the embodiments are not limited to UE location information obtained through GNSS measurement, but may be applied to, or adapted to, scenarios where the UE location information is obtained through any available (sufficiently reliable and accurate) means, such as radio transmission beacons (e.g., relevant signals transmitted by Bluetooth or Wi-Fi access points), UE internal sensors (e.g., accelerometer(s), gyroscope(s), compass(es), tilt sensor(s), etc.) or a combination of any of these means.

In another generalization of any or all of the embodiments herein, although particular embodiments have been described in terms using the GNSS status information in conjunction with handover, the solution is not limited to handovers, and may be applied to, or adapted to, using the GNSS status information in conjunction with any mobility procedure in RRC_CONNECTED state.

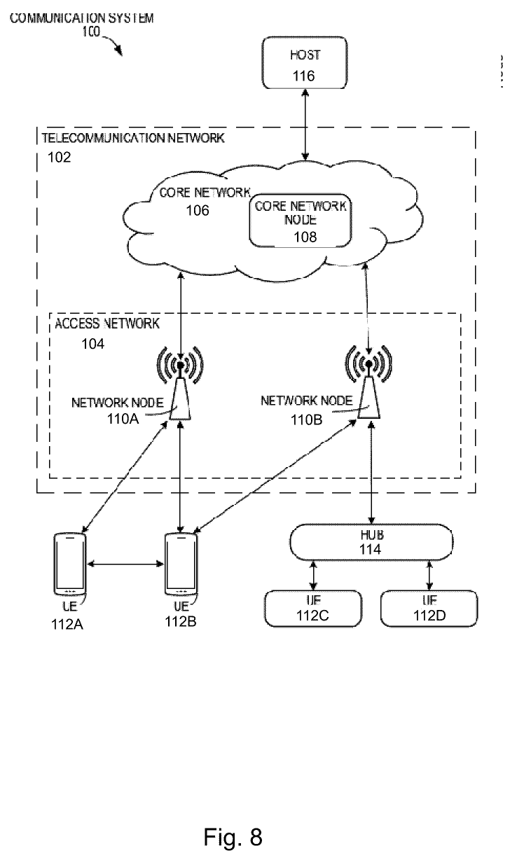

FIG. 8 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

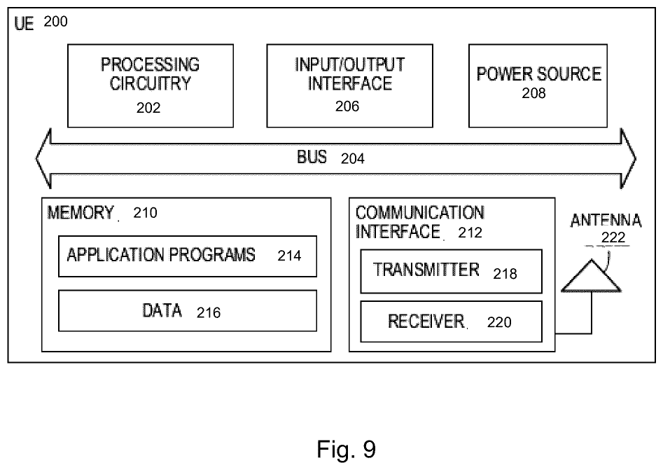

FIG. 9 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

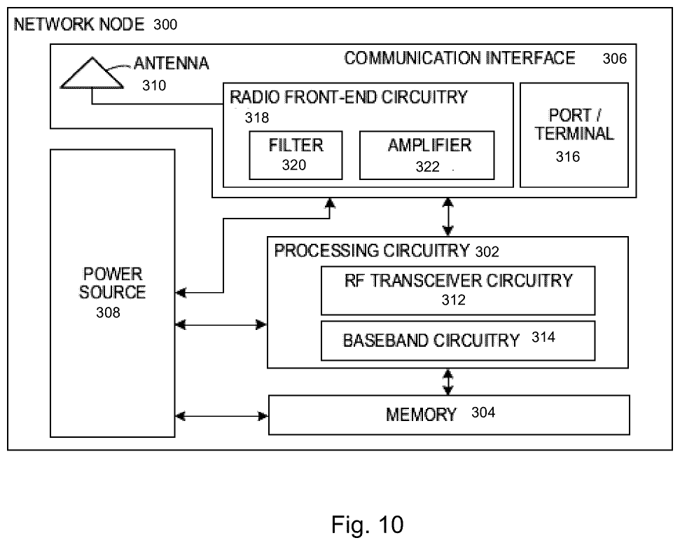

FIG. 10 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

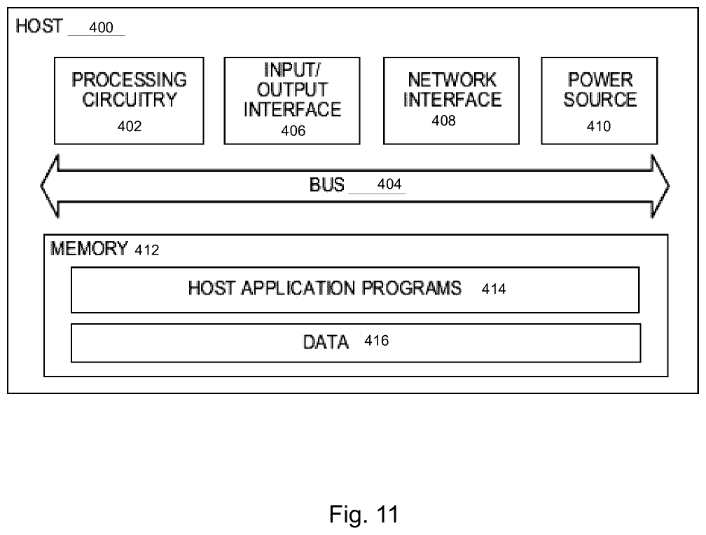

FIG. 11 is a block diagram of a host 400, which may be an embodiment of the host 116 of 1 FIG. 8, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

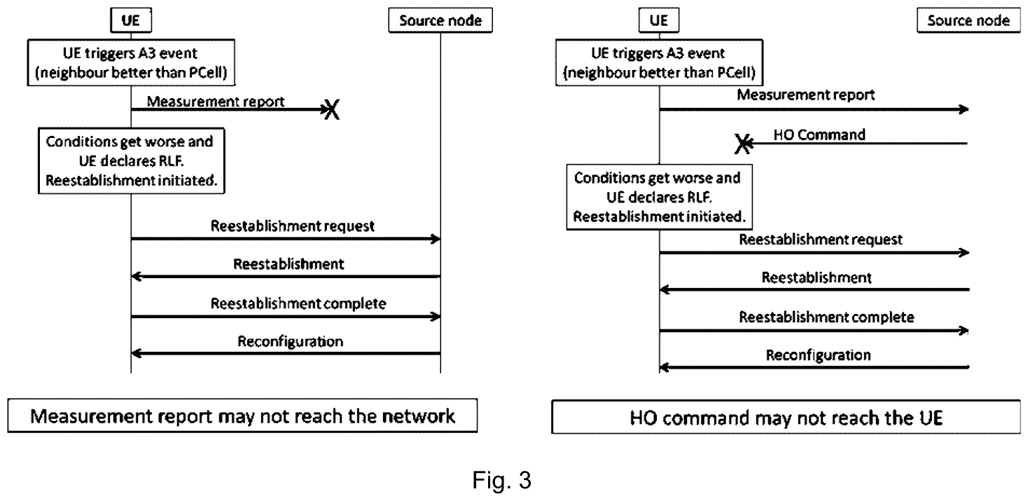

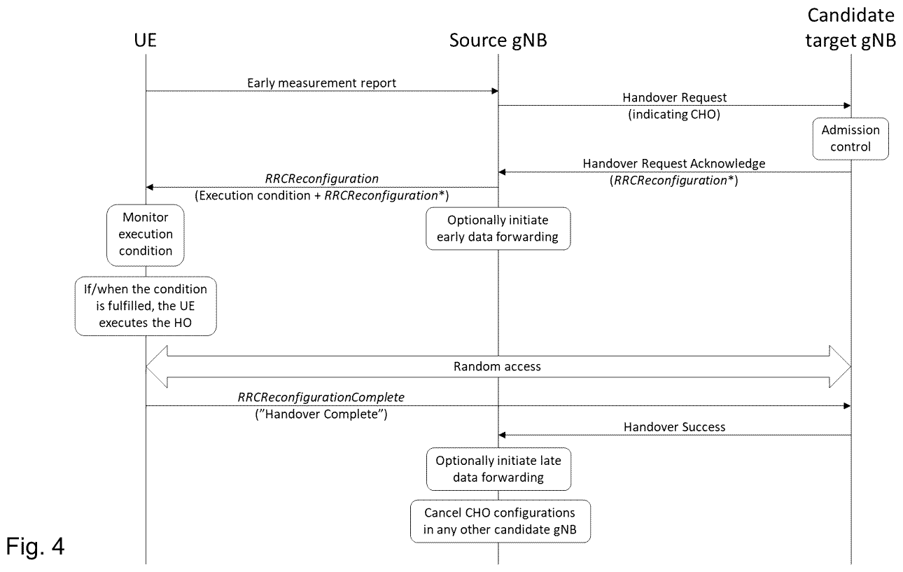

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

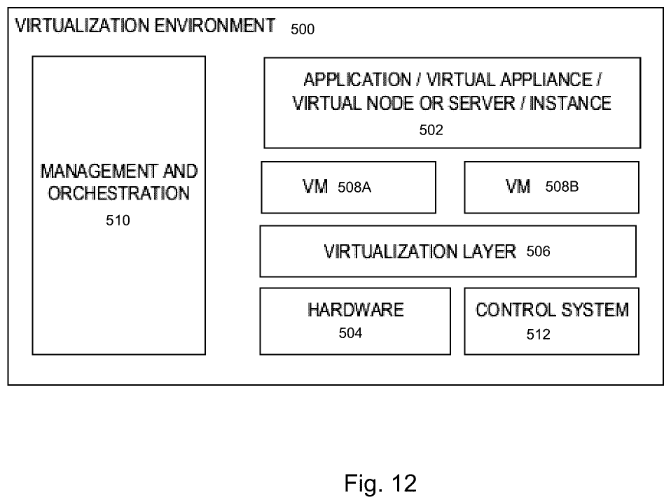

FIG. 12 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

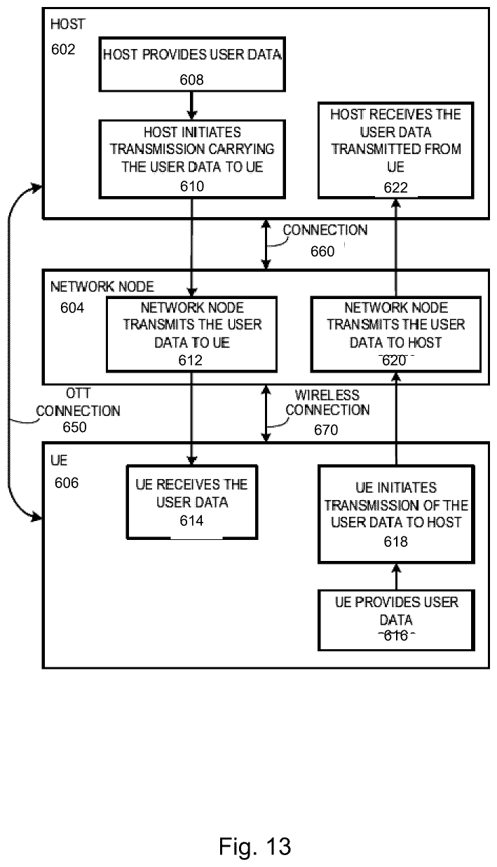

FIG. 13 shows a communication diagram of a host 602 communicating via a network node 604 with a UE 606 over a partially wireless connection in accordance with some embodiments. Example implementations, in accordance with various embodiments, of the UE (such as a UE 112a of FIG. 8 and/or UE 200 of FIG. 9), network node (such as network node 110a of FIG. 8 and/or network node 300 of FIG. 10), and host (such as host 116 of FIG. 8 and/or host 400 of FIG. 11) discussed in the preceding paragraphs will now be described with reference to FIG. 13.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 8) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

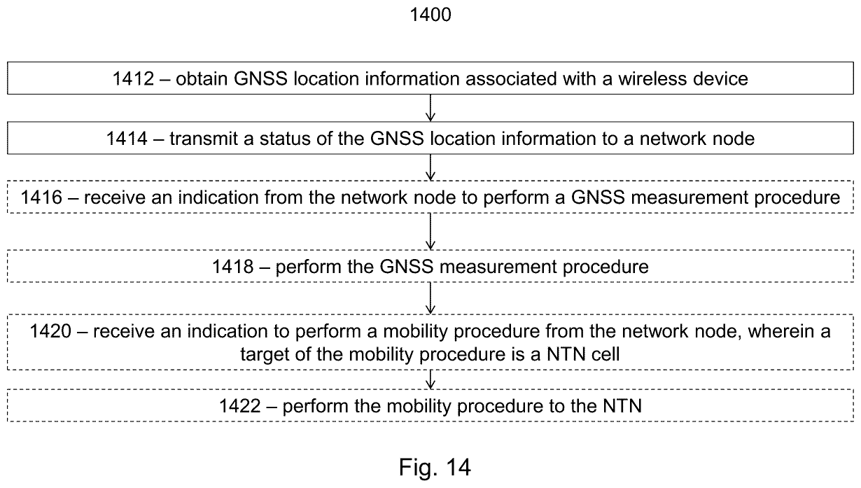

FIG. 14 is a flowchart illustrating an example method in a wireless device, according to certain embodiments. In particular embodiments, one or more steps of FIG. 14 may be performed by UE 200 described with respect to FIG. 9.

The method begins at step 1412, where the wireless device (e.g., UE 200) obtains GNSS location information associated with the wireless device. For example, during the course of operation the wireless device may perform a GNSS measurement.

As described in more detail above, the wireless device may determine the distance to GNSS satellites by receiving transmissions from the GNSS satellites, which requires that the wireless device knows the positions of the satellites. Thus, the GNSS satellites also transmit data about their own orbits (from which position at a certain time can be derived). In GPS, such information is referred to as ephemeris data and almanac data (or sometimes lumped together under the term navigation information).

The time required to perform a GNSS measurement may vary depending on, for example, the status of the ephemeris and almanac data the wireless device has previously acquired (if any).

GNSS location information may be used, as described in more detail above, when performing a mobility procedure to a NTN. For example, the GNSS location information may be used for determining a timing advance or Doppler effect.

At step 1414, the wireless device transmits a status of the GNSS location information to a network node. The status may comprise a remaining amount of time that the GNSS location information is valid. The status may comprise any one or more of: availability or lack of availability of valid GNSS location information, GNSS measurement state, a time since a last GNSS measurement, and a time T to acquire valid GNSS location information.

In particular embodiments, the GNSS measurement state comprises a starting type of a GNS receiver. The starting type comprises an indication of an amount of usable data from a previously acquired GNSS measurement. For example, the starting type may comprise one of a hot start, a warm start, and a cold start.

In particular embodiments, transmitting the status of the GNSS location information to a network node comprises transmitting the status in a measurement report (e.g., radio resource control (RRC) message).

The network node may use the status of the GNSS location information to make decisions regarding network operations, such as a mobility procedure to a NTN network. For example, the network node may determine whether the GNSS location information is usable for the network operation, or whether the wireless device should acquire new GNSS location information. If the wireless device needs to acquire new GNSS location information, the network node may determine how long the wireless device may need to acquire the GNSS location information, and configure network parameters (e.g., mobility timers) accordingly.

The status of the GNSS location information may include any of the status information described with respect to any of the embodiments and examples described herein.

At step 1416, the wireless device may receive an indication from the network node to perform a GNSS measurement procedure. For example, the network node may have determined the wireless device needs to acquire new GNSS location information before performing a mobility procedure. In some embodiments, the wireless device may receive the indication to perform the GNSS measurement procedure prior to sending the status of the GNSS location information to the network node at step 1414.

At step 1418, the wireless device may perform a GNSS measurement procedure. In some embodiments, the wireless device may perform the GNSS measurement procedure in response to the indication from the network node received at optional step 1416. In other embodiments, the wireless device may autonomously determine to perform the GNSS measurement procedure based on the status of the GNSS location information.

At step 1420, the wireless device receives an indication to perform a mobility procedure from the network node. A target of the mobility procedure is a NTN cell.

In some embodiments, the wireless device may perform the GNSS measurement procedure of step 1418 after receiving the indication to perform the mobility procedure.

At step 1422, the wireless device performs the mobility procedure to the NTN. The wireless device may use the GNSS location information during the mobility procedure, for example, to determine a timing advance value.

Modifications, additions, or omissions may be made to method 1400 of FIG. 14. Additionally, one or more steps in the method of FIG. 14 may be performed in parallel or in any suitable order.

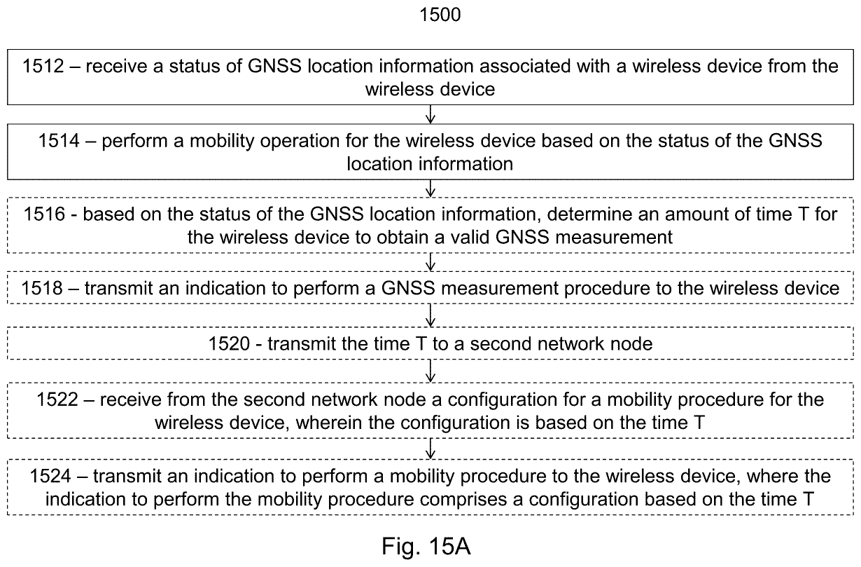

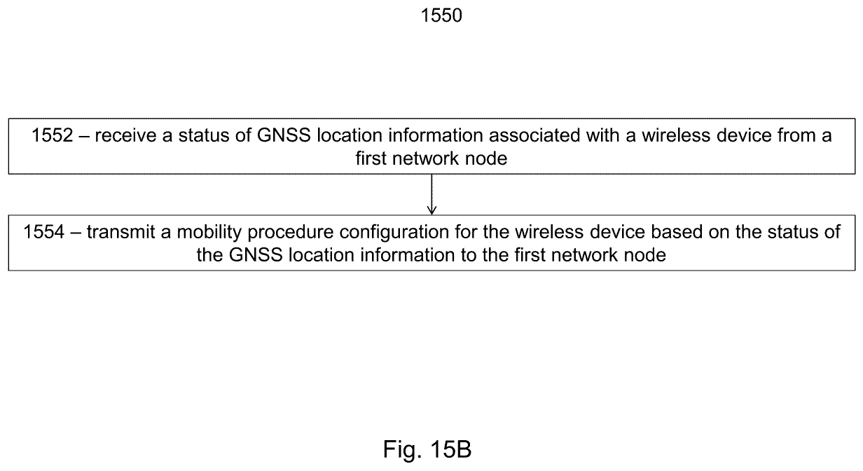

FIG. 15A is a flowchart illustrating an example method in a first network node, according to certain embodiments. In particular embodiments, one or more steps of FIG. 15A may be performed by network node 300 described with respect to FIG. 10. The first network node may be a source network node for a mobility procedure.

The method begins at step 1512, where the network node (e.g., network node 300) receives a status of GNSS location information associated with a wireless device from the wireless device. The status of GNSS location information is described in more detail with respect to step 1414 of FIG. 14.

At step 1514, the network node perform a mobility operation for the wireless device based on the status of the GNSS location information. For example, the network node may determine whether the wireless device needs to acquire new GNSS location information before performing the mobility procedure and how long the acquiring may take. The network node may configure mobility parameters (e.g., timers) accordingly. In some embodiments, the network node may determine not to perform a mobility operation based on the status of the GNSS location information.

At step 1516, the network node may, based on the status of the GNSS location information, determine an amount of time T for the wireless device to obtain a valid GNSS measurement.

At step 1518, the network node may transmit an indication to perform a GNSS measurement procedure to the wireless device. For example, based on the status of the GNSS location information, the network node may determine that the wireless device needs to acquire new GNSS location information.

At step 1520, the network node may transmit the time T to a second network node. The second network node may comprise a target network node for the mobility procedure. Based on the time T, the second network node may determine configuration parameters for a network operation, such as a mobility procedure.

At step 1522, the network node may receive from the second network node a configuration for a mobility procedure for the wireless device. The configuration is based on the time T.

At step 1524, the network node may transmit an indication to perform a mobility procedure to the wireless device. The indication to perform the mobility procedure comprises a configuration based on the time T.

Modifications, additions, or omissions may be made to method 1500 of FIG. 15A. Additionally, one or more steps in the method of FIG. 15A may be performed in parallel or in any suitable order.

FIG. 15B is a flowchart illustrating an example method in a second network node, according to certain embodiments. In particular embodiments, one or more steps of FIG. 15B may be performed by network node 300 described with respect to FIG. 10. The network node may be a target network node for a mobility procedure.

The method begins at step 1552, where the network node (e.g., network node 300) receives a status of GNSS location information associated with a wireless device from a first network node. The status of the GNSS location information is described in more detail with respect to step 1414 of FIG. 14. The network node may use the status of the GNSS location information to determine configuration parameters for a mobility procedure.

At step 1554, the network node transmits a mobility procedure configuration for the wireless device based on the status of the GNSS location information to the first network node.

Modifications, additions, or omissions may be made to method 1550 of FIG. 15B. Additionally, one or more steps in the method of FIG. 15B may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### GROUP A EMBODIMENTS

1. A method performed by a wireless device, the method comprising:
   determining a status of location information associated with the wireless device;
   and
transmitting the status to a network node.
2. The method of the previous embodiment, wherein status comprises any one or more of
availability or lack of availability of valid wireless device location information,
global navigation satellite system (GNSS) measurement state,
a time since a last measurement,
a remaining amount of time that the location information is valid, and
a time T to acquire valid location information.
3. The method of any one of the previous embodiments, wherein transmitting the status to a network node comprises transmitting the status in a measurement report.
4. A method performed by a wireless device, the method comprising:
   any of the wireless device steps, features, or functions described above, either alone or in combination with other steps, features, or functions described above.
5. The method of the previous embodiment, further comprising one or more additional wireless device steps, features or functions described above.
6. The method of any of the previous embodiments, further comprising:
   providing user data; and
   forwarding the user data to a host computer via the transmission to the base station.

### GROUP B EMBODIMENTS

7. A method performed by a base station, the method comprising:
   a. receiving a status of location information associated with a wireless device from the wireless device; and
   b. determining whether to perform a mobility operation for the wireless device based on the status.
8. The method of the previous embodiment, wherein status comprises any one or more of
   availability or lack of availability of valid wireless device location information,
   global navigation satellite system (GNSS) measurement state,
   a time since a last measurement,
   a remaining amount of time that the location information is valid, and
   a time T to acquire valid location information.
9. The method of any one of the previous embodiments, wherein receiving the status from the wireless device comprises receiving the status in a measurement report.
10. A method performed by a base station, the method comprising:
   any of the steps, features, or functions described above with respect to base station, either alone or in combination with other steps, features, or functions described above.
11. The method of the previous embodiment, further comprising one or more additional base station steps, features or functions described above.
12. The method of any of the previous embodiments, further comprising:
   obtaining user data; and
   forwarding the user data to a host computer or a wireless device.

### GROUP C EMBODIMENTS

13. A mobile terminal comprising:
   processing circuitry configured to perform any of the steps of any of the Group A embodiments; and
   power supply circuitry configured to supply power to the wireless device.
14. A base station comprising:
   processing circuitry configured to perform any of the steps of any of the Group B embodiments;
   power supply circuitry configured to supply power to the wireless device.
15. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
16. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
17. The communication system of the pervious embodiment further including the base station.
18. The communication system of the previous 2 embodiments, further including the UE, wherein the UE is configured to communicate with the base station.
19. The communication system of the previous 3 embodiments, wherein:
   the processing circuitry of the host computer is configured to execute a host application, thereby providing the user data; and
   the UE comprises processing circuitry configured to execute a client application associated with the host application.
20. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
21. The method of the previous embodiment, further comprising, at the base station, transmitting the user data.
22. The method of the previous 2 embodiments, wherein the user data is provided at the host computer by executing a host application, the method further comprising, at the UE, executing a client application associated with the host application.
23. A user equipment (UE) configured to communicate with a base station, the UE comprising a radio interface and processing circuitry configured to performs any of the previous 3 embodiments.
24. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
25. The communication system of the previous embodiment, wherein the cellular network further includes a base station configured to communicate with the UE.
26. The communication system of the previous 2 embodiments, wherein:
   the processing circuitry of the host computer is configured to execute a host application, thereby providing the user data; and
   the UE's processing circuitry is configured to execute a client application associated with the host application.
27. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
28. The method of the previous embodiment, further comprising at the UE, receiving the user data from the base station.
29. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
30. The communication system of the previous embodiment, further including the UE.
31. The communication system of the previous 2 embodiments, further including the base station, wherein the base station comprises a radio interface configured to communicate with the UE and a communication interface configured to forward to the host computer the user data carried by a transmission from the UE to the base station.
32. The communication system of the previous 3 embodiments, wherein:
   the processing circuitry of the host computer is configured to execute a host application; and
   the UE's processing circuitry is configured to execute a client application associated with the host application, thereby providing the user data.
33. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
34. A method implemented in a communication system including a host computer, a base station and a user equipment (UE), the method comprising:
   at the host computer, receiving user data transmitted to the base station from the UE, wherein the UE performs any of the steps of any of the Group A embodiments.
35. The method of the previous embodiment, further comprising, at the UE, providing the user data to the base station.
36. The method of the previous 2 embodiments, further comprising:
   at the UE, executing a client application, thereby providing the user data to be transmitted; and
   at the host computer, executing a host application associated with the client application.
37. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
38. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
39. The communication system of the previous embodiment further including the base station.
40. The communication system of the previous 2 embodiments, further including the UE, wherein the UE is configured to communicate with the base station.
41. The communication system of the previous 3 embodiments, wherein:
   the processing circuitry of the host computer is configured to execute a host application;
   the UE is configured to execute a client application associated with the host application, thereby providing the user data to be received by the host computer.
42. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
43. The method of the previous embodiment, further comprising at the base station, receiving the user data from the UE.
44. The method of the previous 2 embodiments, further comprising at the base station, initiating a transmission of the received user data to the host computer.

1. A method performed by a wireless device, the method comprising:
obtaining global navigation satellite system (GNSS) location information associated with the wireless device; and
transmitting a status of the GNSS location information to a network node.

2. The method of claim 1, wherein the status comprises a remaining amount of time that the GNSS location information is valid.

3. The method of claim 1, wherein the status comprises any one or more of:
availability or lack of availability of valid GNSS location information,
GNSS measurement state,
a time since a last GNSS measurement, and
a time T to acquire valid GNSS location information.

4. The method of claim 3, wherein the GNSS measurement state comprises a starting type of a GNS receiver, wherein the starting type comprises an indication of an amount of usable data from a previously acquired GNSS measurement.

5. The method of claim 4, wherein the starting type comprises one of a hot start, a warm start, and a cold start.

6. The method of claim 1, wherein transmitting the status of the GNSS location information to a network node comprises transmitting the status in a measurement report.

7. The method of claim 1, further comprising, upon transmitting the indication of the status to the network node, performing a GNSS measurement procedure.

8. The method of claim 1, further comprising:
receiving an indication from the network node to perform a GNSS measurement procedure; and
performing the GNSS measurement procedure.

9. The method of claim 1, further comprising:
receiving an indication to perform a mobility procedure from the network node, wherein a target of the mobility procedure is a non-terrestrial network (NTN) cell;
performing a GNSS measurement procedure; and
performing the mobility procedure to the NTN.

10. The method of claim 9, wherein performing the mobility procedure to the NTN cell comprises determining a timing advance based on the GNSS measurement.

11. A wireless device comprising processing circuitry operable to:
obtain global navigation satellite system (GNSS) location information associated with the wireless device; and
transmit a status of the GNSS location information to a network node.

12-14. (canceled)

15. A method performed by a first network node, the method comprising:
receiving a status of global navigation satellite system (GNSS) location information associated with a wireless device from the wireless device; and
performing a mobility operation for the wireless device based on the status of the GNSS location information.

16. The method of claim 15, wherein the status comprises a remaining amount of time that the GNSS location information is valid.

17. The method of claim 15, wherein the status comprises any one or more of:
availability or lack of availability of valid GNSS location information,
GNSS measurement state,
a time since a last GNSS measurement, and
a time T to acquire valid GNSS location information.

18. The method of claim 15, wherein receiving the status of the GNSS location information from the wireless device comprises receiving the status in a measurement report.

19. The method of claim 15, further comprising, based on the status of the GNSS location information, determining an amount of time T for the wireless device to obtain a valid GNSS measurement.

20. The method of claim 19, further comprising transmitting the time T to a second network node.

21. The method of claim 20, further comprising receiving from the second network node a configuration for a mobility procedure for the wireless device, wherein the configuration is based on the time T.

22. The method of claim 19, further comprising, transmitting an indication to perform a mobility procedure to the wireless device, where the indication to perform the mobility procedure comprises a configuration based on the time T.

23. The method of claim 15, further comprising, transmitting an indication to perform a GNSS measurement procedure to the wireless device.

24. The method of claim 15, wherein the mobility procedure comprises a mobility procedure to a non-terrestrial network (NTN) cell.

25. A first network node comprising processing circuitry operable to:
receive a status of global navigation satellite system (GNSS) location information associated with a wireless device from the wireless device; and
perform a mobility operation for the wireless device based on the status of the GNSS location information.

26.-36. (canceled)
